(19) United States
(12) Patent Application Publication
(10) Pub. No.: US 2026/0208560 A1
(43) Pub. Date: Jul. 23, 2026

(54) THERMAL MANAGEMENT SYSTEM OF VEHICLE

(71) Applicants: Hyundai Motor Company, Seoul (KR); Kia Corporation, Seoul (KR)

(72) Inventors: Jian Xiong ZHAO, Yantai (CN); Xinyu CUI, Yantai (CN); Young Jin SEO, Hwaseong-Si (KR); Won Young JEONG, Hwaseong-Si (KR)

(73) Assignees: Hyundai Motor Company, Seoul (KR); Kia Corporation, Seoul (KR)

(21) Appl. No.: 19/427,175

(22) Filed: Dec. 19, 2025

(30) Foreign Application Priority Data
Jan. 23, 2025 (CN) 202510114488.9

(51) Int. Cl. B60H 1/00

(52) U.S. Cl. CPC B60H 1/00907

(57) ABSTRACT

A thermal management system includes a cooling device including at least one electric device, a pump, a radiator, and a first valve sequentially connectable through a coolant line and cooling the at least one electric device; and an air conditioning device that includes a compressor, a condenser, a second valve, an expansion valve, and a heat-exchanger sequentially connectable through a refrigerant line. The cooling device further includes a chiller disposed at a coolant branch line and connected to the air conditioning device to exchange heat with a refrigerant from the air conditioning device as a coolant passes through the coolant branch line, and the air conditioning device further includes a third valve disposed at the refrigerant line downstream of the heat-exchanger, a fourth valve disposed at the refrigerant line downstream of the expansion valve, a first refrigerant branch line, and second, third and fourth refrigerant branch lines.

### CROSS-REFERENCE TO RELATED APPLICATION

The present application claims priority to and the benefit of Chinese Patent Application No. 202510114488.9 filed with the Chinese National Intellectual Property Administration on Jan. 23, 2025, the entire contents of which are incorporated herein by reference.

### BACKGROUND OF THE PRESENT DISCLOSURE

### Field of the Present Disclosure

The present disclosure relates to a thermal management system of a vehicle, and more particularly, to a thermal management system of a vehicle realized using a new four-way valve that is capable of improving cooling performance of a motor to enable the motor to stably and continuously output high electric power.

### Description of Related Art

An electric vehicle is driven using a motor as a power source. A main type of the motor currently used in the electric vehicle is a permanent magnet synchronous motor, and the permanent magnet synchronous motor has an advantage of high efficiency and a wide range of rotational adjustment control. However, because a permanent magnet is greatly affected by a temperature, the permanent magnet may easily be demagnetized at a high temperature to cause irreversible performance degradation. Accordingly, the permanent magnet synchronous motor has a disadvantage of not being able to stably and continuously output high electric power. Therefore, if the permanent magnet synchronous motor requires high-performance output, it is very important to secure cooling performance of the permanent magnet synchronous motor.

Unlike an internal combustion engine vehicle, the electric vehicle may not include an engine so that the interior of the vehicle is not heated using waste heat of the engine in a cold environment. To achieve heating of the vehicle cabin in the cold environment, the electric vehicle generally includes an electric heater (e.g., a positive temperature coefficient (PTC) heater). However, if the electric heater is used for the heating, electrical energy consumption of the electric vehicle is increased so that a driving distance of the electric vehicle in winter is significantly shortened and marketability of the electric vehicle deteriorates. If the motor is operated, the waste heat may be generated. If the waste heat generated when the motor is operated is used to heat the interior of the vehicle, it is possible to save electrical energy by reducing use of the electric heater.

Therefore, it is necessary to provide a thermal management system of a vehicle capable of improving cooling performance of the motor so that the motor stably and continuously outputs high electric power, and the thermal management system of the vehicle capable of effectively utilizing the waste heat generated when the motor is operated to secure the driving distance of the electric vehicle in winter.

The above information disclosed in this Background section is only for enhancement of understanding of the background of the present disclosure, and therefore it may include information that does not form the related art that is already known to a person of ordinary skill in the art.

### BRIEF SUMMARY

An exemplary embodiment of the present disclosure is directed to providing a thermal management system of a vehicle that improves cooling performance of a motor to enable the motor to stably and continuously output high electric power.

According to various aspects of the present disclosure, a thermal management system of a vehicle is provided. The thermal management system includes: a cooling device that includes at least one electric device, a pump, a radiator, and a first valve sequentially connectable through a coolant line and is configured to cool the at least one electric device; and an air conditioning device that includes a compressor, a condenser, a second valve, an expansion valve, and a heat-exchanger sequentially connectable through a refrigerant line.

According to various aspects of the present disclosure, the cooling device may further include: a coolant branch line including a first end portion connected to the coolant line downstream of the pump and a second end portion connected to the coolant line upstream of the at least one electric device through a first valve; and a chiller that is disposed at the coolant branch line and is connected to the air conditioning device so that a coolant in the coolant branch line passes through the chiller and exchanges heat with a refrigerant from the air conditioning device in the chiller.

According to various aspects of the present disclosure, the air conditioning device may further include: a third valve disposed at the refrigerant line downstream of the heat-exchanger; a fourth valve disposed at the refrigerant line downstream of the expansion valve; a first refrigerant branch line including a first end portion connected to the refrigerant line downstream of the condenser through the second valve and a second end portion connected to the refrigerant line downstream of the heat-exchanger; a second refrigerant branch line that has a first end portion connected to the third valve and a second end portion connected to the refrigerant line upstream of the compressor, wherein the chiller is disposed at the second refrigerant branch line to be connectable to the air conditioning device; a third refrigerant branch line including a first end portion connected to the refrigerant line downstream of the compressor and a second end portion connected to the fourth valve; and a fourth refrigerant branch line including a first end portion connected to the fourth valve and a second end portion connected to the third valve.

According to various aspects of the present disclosure, the third valve may be a four-way valve, a first port of the third valve may be connected to the second end portion of the fourth refrigerant branch line, a second port of the third valve may be connected to the refrigerant line downstream of the heat-exchanger, a third port of the third valve may be connected to the refrigerant line upstream of the compressor, and a fourth port of the third valve may be connected to the first end portion of the second refrigerant branch line, and the fourth valve may be a four-way valve, a first port of the fourth valve may be connected to the refrigerant line downstream of the expansion valve, a second port of the fourth valve may be connected to the second end portion of the third refrigerant branch line, a third port of the fourth valve may be connected to the refrigerant line upstream of the heat-exchanger, and a fourth port of the fourth valve may be connected to the first end portion of the fourth refrigerant branch line.

According to various aspects of the present disclosure, the first valve may be a three-way valve, a first port of the first valve may be connected to the coolant line downstream of the radiator, a second port of the first valve may be connected to the coolant line upstream of the at least one electric device, and a third port of the first valve may be connected to the coolant branch line downstream of the chiller, and the second valve may be a three-way valve, a first port of the second valve may be connected to the refrigerant line downstream of the condenser, a second port of the second valve may be connected to the refrigerant line upstream of the expansion valve, and a third port of the second valve may be connected to the first refrigerant branch line.

According to various aspects of the present disclosure, the coolant line may include: a first coolant line including a first end portion connected to the second port of the first valve and a second end portion connected to a downstream of the pump and a second coolant line including a first end portion connected to the second end portion of the first coolant line and a second end portion connected to the first port of the first valve. A diameter of the first coolant line may be greater than a diameter of the coolant branch line, and the diameter of the coolant branch line may be greater than a diameter of the second coolant line.

According to various aspects of the present disclosure, the refrigerant line may include: a first refrigerant line including a first end portion connected to an outlet of the compressor and a second end portion connected to the first end portion of the third refrigerant branch line; a second refrigerant line including a first end portion connected to the second end portion of the first refrigerant line and a second end portion connected to the first port of the second valve; a third refrigerant line including a first end portion connected to the second port of the second valve and a second end portion connected to the first port of the fourth valve; a fourth refrigerant line including a first end portion connected to the third port of the fourth valve and a second end portion connected to the second port of the third valve; and a fifth refrigerant line including a first end portion connected to the third port of the third valve and a second end portion connected to an inlet of the compressor.

According to various aspects of the present disclosure, the thermal management system may further include: a cooling fan disposed at the rear of the radiator and the condenser; a vehicle speed sensor detecting a vehicle speed; a temperature sensor detecting a temperature of a motor; and an accelerator pedal opening degree sensor detecting an accelerator pedal opening degree.

According to various aspects of the present disclosure, in a case in which the air conditioning device performs heating of the vehicle cabin, the thermal management system may be configured to execute a first mode if the temperature of the motor is less than a first predetermined temperature and the accelerator pedal opening degree is less than a first predetermined opening degree, and the thermal management system may be configured to execute a second mode if the temperature of the motor is greater than or equal to the first predetermined temperature or the accelerator pedal opening degree is greater than or equal to the first predetermined opening degree; in a case in which the air conditioning device performs cooling of the vehicle cabin, the thermal management system may be configured to execute a third mode if the temperature of the motor is less than a second predetermined temperature and the accelerator pedal opening degree is less than a second predetermined opening degree and the thermal management system may be configured to execute a fourth mode if the temperature of the motor is greater than or equal to the second predetermined temperature or the accelerator pedal opening degree is greater than or equal to the second predetermined opening degree; in a case in which the air conditioning device is not operated, the thermal management system may be configured to execute a fifth mode if the temperature of the motor is greater than or equal to the second predetermined temperature or the accelerator pedal opening degree is greater than or equal to the second predetermined opening degree; the thermal management system may be configured to execute a sixth mode if a driving mode of the vehicle is a super performance mode; and the thermal management system may be configured to execute a seventh mode if the driving mode of the vehicle is a safety mode.

According to various aspects of the present disclosure, in the first mode, the first port of the first valve may be closed and the second port and the third port of the first valve may be opened to fluidically-communicate the first coolant line with the coolant branch line and block the second coolant line; the first port of the second valve may be closed, and the second port and the third port of the second valve may be opened; the first port of the third valve may fluidically-communicate with the fourth port of the third valve, and the second port and the third port of the third valve may be closed; the first port of the fourth valve may fluidically-communicate with the fourth port of the fourth valve, and the second port of the fourth valve may fluidically-communicate with the third port of the fourth valve to sequentially fluidically-communicate the first refrigerant line, the third refrigerant branch line, the fourth refrigerant line, the first refrigerant branch line, the third refrigerant line, the fourth refrigerant branch line, the second refrigerant branch line, and the fifth refrigerant line; the expansion valve may expand the refrigerant flowing into the chiller; and the pump and the compressor may be operated so that waste heat generated by the at least one electric device is recovered using the chiller for heating of the vehicle cabin.

According to various aspects of the present disclosure, a rotation speed of the pump may be determined according to the driving mode of the vehicle and the temperature of the motor, and the pump may be operated according to the determined rotation speed.

According to various aspects of the present disclosure, in the second mode, the first port, the second port, and the third port of the first valve may be opened so that the first coolant line fluidically-communicates with both the second coolant line and the coolant branch line; the first port of the second valve may be closed, and the second port and the third port of the second valve may be opened; the first port of the third valve may fluidically-communicate with the fourth port of the third valve, and the second port and the third port of the third valve may be closed; the first port of the fourth valve may fluidically-communicate with the fourth port of the fourth valve, and the second port of the fourth valve may fluidically-communicate with the third port of the fourth valve to sequentially fluidically-communicate the first refrigerant line, the third refrigerant branch line, the fourth refrigerant line, the first refrigerant branch line, the third refrigerant line, the fourth refrigerant branch line, the second refrigerant branch line, and the fifth refrigerant line; the expansion valve may expand the refrigerant flowing into the chiller; and the pump and the compressor may be operated so that waste heat generated by the at least one electric device is recovered using the chiller for heating of the vehicle cabin and simultaneously the at least one electric device is further cooled using the radiator.

According to various aspects of the present disclosure, the rotation speed of the pump may be determined according to the driving mode of the vehicle and the temperature of the motor and the pump may be operated according to the determined rotation speed; and the temperature of the motor after modification may be determined according to the temperature of the motor detected by the temperature sensor, a duty cycle of the cooling fan corresponding to the temperature of the motor after modification may be determined according to the driving mode of the vehicle and the temperature of the motor after modification, a duty cycle of the cooling fan corresponding to the accelerator pedal opening degree may be determined according to the driving mode of the vehicle and the accelerator pedal opening degree detected by the accelerator pedal opening degree sensor, a larger value between the duty cycle of the cooling fan corresponding to the temperature of the motor after modification and the duty cycle of the cooling fan corresponding to the accelerator pedal opening degree may be determined as a duty cycle for controlling an operation of the cooling fan, and the cooling fan may be operated at the determined duty cycle.

According to various aspects of the present disclosure, in the third mode, the first port and the second port of the first valve may be opened and the third port of the first valve may be closed to fluidically-communicate the first coolant line with the second coolant line and block the coolant branch line; the first port and the second port of the second valve may be opened, and the third port of the second valve may be closed; the first port and the fourth port of the third valve may be closed, and the second port of the third valve may fluidically-communicate with the third port of the third valve; the first port of the fourth valve may fluidically-communicate with the third port of the fourth valve, and the second port and the fourth port of the fourth valve may be closed to sequentially fluidically-communicate the first refrigerant line, the second refrigerant line, the third refrigerant line, the fourth refrigerant line, and the fifth refrigerant line; the expansion valve may expand the refrigerant flowing into the heat-exchanger; and the pump and the compressor may be operated so that the at least one electric device is cooled using the radiator and cooling of the vehicle cabin is performed using the air conditioning device.

According to various aspects of the present disclosure, the rotation speed of the pump may be determined according to the driving mode of the vehicle and the temperature of the motor and the pump may be operated according to the determined rotation speed; and the temperature of the motor after modification may be determined according to the temperature of the motor detected by the temperature sensor, a duty cycle of the cooling fan corresponding to the temperature of the motor after modification may be determined according to the driving mode of the vehicle and the temperature of the motor after modification, a duty cycle of the cooling fan corresponding to the accelerator pedal opening degree may be determined according to the driving mode of the vehicle and the accelerator pedal opening degree detected by the accelerator pedal opening degree sensor, a larger value between the duty cycle of the cooling fan corresponding to the temperature of the motor after modification and the duty cycle of the cooling fan corresponding to the accelerator pedal opening degree may be determined as a duty cycle for controlling an operation of the cooling fan, and the cooling fan may be operated at the determined duty cycle.

According to various aspects of the present disclosure, in the fourth mode, the first port of the first valve may be closed and the second port and the third port of the first valve may be opened to fluidically-communicate the first coolant line with the coolant branch line and block the second coolant line; the first port and the second port of the second valve may be opened, and the third port of the second valve may be closed; the first port and the third port of the third valve may be closed, and the second port of the third valve may fluidically-communicate with the fourth port of the third valve; the first port of the fourth valve may fluidically-communicate with the third port of the fourth valve, and the second port and the fourth port of the fourth valve may be closed to sequentially fluidically-communicate the first refrigerant line, the second refrigerant line, the third refrigerant line, the fourth refrigerant line, the second refrigerant branch line, and the fifth refrigerant line; the expansion valve may expand the refrigerant flowing into the heat-exchanger and the chiller; and the pump and the compressor may be operated so that the at least one electric device is cooled using the chiller and cooling of the vehicle cabin is performed using the air conditioning device.

According to various aspects of the present disclosure, the rotation speed of the pump may be determined according to the driving mode of the vehicle and the temperature of the motor and the pump may be operated according to the determined rotation speed; and the temperature of the motor after modification may be determined according to the temperature of the motor detected by the temperature sensor, a duty cycle of the cooling fan corresponding to the temperature of the motor after modification may be determined according to the driving mode of the vehicle and the temperature of the motor after modification, a duty cycle of the cooling fan corresponding to the accelerator pedal opening degree may be determined according to the driving mode of the vehicle and the accelerator pedal opening degree detected by the accelerator pedal opening degree sensor, a larger value between the duty cycle of the cooling fan corresponding to the temperature of the motor after modification and the duty cycle of the cooling fan corresponding to the accelerator pedal opening degree may be determined as a duty cycle for controlling an operation of the cooling fan, and the cooling fan may be operated at the determined duty cycle.

According to various aspects of the present disclosure, in the fifth mode, the sixth mode, and the seventh mode, the first port of the first valve may be closed and the second port and the third port of the first valve may be opened to fluidically-communicate the first coolant line with the coolant branch line and block the second coolant line; the first port and the second port of the second valve may be opened, and the third port of the second valve may be closed; the first port of the third valve may fluidically-communicate with the fourth port of the third valve, and the second port and the third port of the third valve may be closed; the first port of the fourth valve may fluidically-communicate with the fourth port of the fourth valve, and the second port and the third port of the fourth valve may be closed to fluidically-communicate the first refrigerant line, the second refrigerant line, the third refrigerant line, the fourth refrigerant branch line, the second refrigerant branch line, and the fifth refrigerant line; the expansion valve may expand a refrigerant flowing into the chiller; and the pump and the compressor may be operated so that the at least one electric device is cooled using the chiller.

According to various aspects of the present disclosure, in the fifth mode, the rotation speed of the pump may be determined according to the driving mode of the vehicle and the temperature of the motor and the pump may be operated according to the determined rotation speed; and the temperature of the motor after modification may be determined according to the temperature of the motor detected by the temperature sensor, a duty cycle of the cooling fan corresponding to the temperature of the motor after modification may be determined according to the driving mode of the vehicle and the temperature of the motor after modification, a duty cycle of the cooling fan corresponding to the accelerator pedal opening degree may be determined according to the driving mode of the vehicle and the accelerator pedal opening degree detected by the accelerator pedal opening degree sensor, a larger value between the duty cycle of the cooling fan corresponding to the temperature of the motor after modification and the duty cycle of the cooling fan corresponding to the accelerator pedal opening degree may be determined as a duty cycle for controlling an operation of the cooling fan, and the cooling fan may be operated at the determined duty cycle.

According to various aspects of the present disclosure, in the sixth mode, a rotation speed of the pump may be determined according to the super performance mode and the temperature of the motor and the pump may be operated according to the determined rotation speed; and the temperature of the motor after modification may be determined according to the temperature of the motor detected by the temperature sensor, a duty cycle of the cooling fan corresponding to the temperature of the motor after modification may be determined according to the super performance mode and the temperature of the motor after modification, a duty cycle of the cooling fan corresponding to the accelerator pedal opening degree may be determined according to the super performance mode and the accelerator pedal opening degree detected by the accelerator pedal opening degree sensor, a larger value between the duty cycle of the cooling fan corresponding to the temperature of the motor after modification and the duty cycle of the cooling fan corresponding to the accelerator pedal opening degree may be determined as a duty cycle for controlling an operation of the cooling fan, and the cooling fan may be operated at the determined duty cycle.

According to various aspects of the present disclosure, in the seventh mode, the vehicle speed may be limited to a predetermined vehicle speed or less; electric power output of a battery may be limited to a predetermined electric power or less; and a rotation speed of the pump may be limited to a predetermined rotation speed or less.

According to various aspects of the present disclosure, the first predetermined temperature, the second predetermined temperature, the first predetermined opening degree, and the second predetermined opening degree may be determined based on a driving mode other than the super performance mode and the safety mode.

According to various aspects of the present disclosure, if the duty cycle of the cooling fan corresponding to the temperature of the motor after modification and the duty cycle of the cooling fan corresponding to the accelerator pedal opening degree are the same, one of the duty cycle of the cooling fan corresponding to the temperature of the motor after modification and the duty cycle of the cooling fan corresponding to the accelerator pedal opening degree may be determined as the duty cycle for controlling the operation of the cooling fan, and the cooling fan may be operated according to the determined duty cycle.

According to various aspects of the present disclosure, the temperature of the motor detected by the temperature sensor may be modified according to the vehicle speed to determine the temperature of the motor after modification.

According to various aspects of the present disclosure, the present disclosure may implement a thermal management system with a new layout including a connection relationship between a line, a valve, and a member using two new four-way valves, and the thermal management system may improve cooling performance of a motor to enable the motor to stably and continuously output high electric power.

Furthermore, an effect obtained or predicted by an exemplary embodiment of the present disclosure is disclosed directly or implicitly in a detailed description of the present disclosure. That is, various effects predicted according to an exemplary embodiment of the present disclosure will be disclosed in the detailed description to be described below.

### BRIEF DESCRIPTION OF THE DRAWINGS

The above-described purpose, feature, and advantage of the present disclosure will be more clearly understood through a detailed description presented below together with the accompanying drawings.

FIG. 1 is a schematic diagram illustrating a thermal management system of a vehicle according to an exemplary embodiment of the present disclosure.

FIG. 2 is a block diagram illustrating the thermal management system of the vehicle according to an exemplary embodiment of the present disclosure.

FIG. 3 is a schematic diagram illustrating a first mode of the thermal management system of the vehicle according to an exemplary embodiment of the present disclosure.

FIG. 4 is a schematic diagram illustrating a second mode of the thermal management system of the vehicle according to an exemplary embodiment of the present disclosure.

FIG. 5 is a schematic diagram illustrating a third mode of the thermal management system of the vehicle according to an exemplary embodiment of the present

### DISCLOSURE

FIG. 6 is a schematic diagram illustrating a fourth mode of the thermal management system of the vehicle according to an exemplary embodiment of the present disclosure.

FIG. 7 is a schematic diagram illustrating a fifth mode, a sixth mode, and a seventh mode of the thermal management system of a vehicle according to an exemplary embodiment of the present disclosure.

It should be understood that the drawings simply show each feature to describe a basic principle of the present disclosure and are not necessarily drawn according to a ratio. In the drawings, the same reference symbol indicates the same or equivalent portion.

### DETAILED DESCRIPTION

The term “vehicle”, “vehicular”, or another similar term used in the present specification should generally be understood to include a mobile vehicle such as a passenger car including a sports utility vehicle (SUV), a bus, a truck, or various commercial vehicles, objects including various boats or ships, an aircraft, a hybrid vehicle, an electric vehicle, a plug-in hybrid electric vehicle, a hydrogen-powered vehicle, another alternative fuel vehicle using fuel obtained from a resource other than petroleum, and the like.

Although an exemplary embodiment of the present disclosure is referred to as performing an exemplary process using a plurality of units, it should be understood that the exemplary process may be performed by one or a plurality of modules. Furthermore, it should be understood that the term “control unit” refers to a hardware device including a memory and a processor. The memory is configured to store a module, and the processor is configured to execute the module to complete one or more processes further described below.

A term used in the present specification is intended only to describe an exemplary embodiment of the present disclosure, and is not intended to limit the present disclosure. Singular forms “a,” “an,” and “the” used herein also include plural forms unless clearly stated otherwise. The term “comprises” used herein specifies presence of a feature, a numerical value, a step, an operation, an element, and/or a component, but does not exclude presence or addition of one or more other features, numerical values, steps, operations, elements, components, and/or combinations thereof. The term “and/or” used herein includes any and all combinations of one or more of the associated listed items.

Hereinafter, a thermal management system of a vehicle according to an exemplary embodiment of the present disclosure will be described with reference to the drawings.

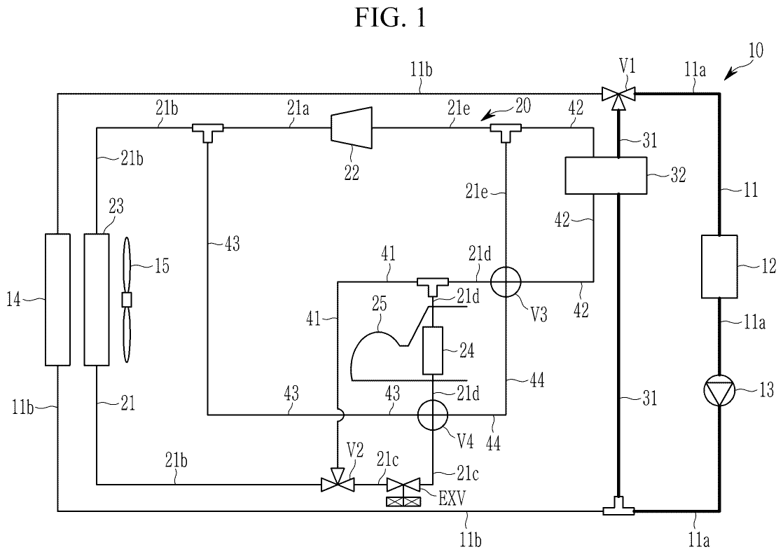

FIG. 1 is a schematic diagram illustrating the thermal management system of the vehicle according to an exemplary embodiment of the present disclosure.

As shown in FIG. 1, the thermal management system of the vehicle may include a cooling device 10 and an air conditioning device 20.

In an exemplary embodiment of the present disclosure, the cooling device 10 may include an electric device 12, a pump 13, a radiator 14, and a first valve V1 sequentially connected through a coolant line 11. The cooling device 10 may include a coolant branch line 31 and a chiller 32. The cooling device 10 may cool the electric device 12 using the radiator 14 and/or the chiller 32.

For example, the coolant line 11 may include a first coolant line 11a and a second coolant line 11b. The electric device 12 and the pump 13 may be disposed at the first coolant line 11a, and the radiator 14 may be disposed at the second coolant line 11b.

The electric device 12 may include various electronic devices within an electric vehicle that consume electric power and generate waste heat such as an onboard charger (OBC), a motor (e.g., a permanent magnet synchronous motor), and various controllers.

The pump 13 may be an electric pump that circulates a coolant in the cooling device 10.

The radiator 14 may be disposed at the front of the vehicle to cool the coolant circulating through the coolant line 11 using an outside air of the vehicle. Therefore, the electric device 12 may be cooled using the coolant cooled in the radiator 14.

The first valve V1 may be a three-way valve, and may be disposed at the coolant line 11 between the radiator 14 and the electric device 12. Three ports of the first valve V1 may be connected to the coolant line 11 and the coolant branch line 31. For example, a first port of the first valve V1 may be connected to the second coolant line 11b downstream of the radiator 14, a second port of the first valve V1 may be connected to the first coolant line 11a upstream of the electric device 12, and a third port of the first valve V1 may be connected to the coolant branch line 31.

Here, the upstream and the downstream may mean upstream and downstream based on a flow direction of the coolant or a refrigerant.

The first valve V1 may be configured for controlling flow of the coolant in the coolant line 11 and the coolant branch line 31. For example, the first valve V1 may selectively fluidically-communicate the second coolant line 11b and/or the coolant branch line 31 with the first coolant line 11a.

One end portion of the coolant branch line 31 may be connected to the first coolant line 11a downstream of the pump 13, and the other end portion of the coolant branch line 31 may be connected to the first coolant line 11a upstream of the electric device 12 through the first valve V1. Accordingly, the coolant passing through the electric device 12 may be selectively controlled to flow into the second coolant line 11b and/or the coolant branch line 31 using the first valve V1.

A diameter of the first coolant line 11a may be greater than a diameter of the coolant branch line 31, and the diameter of the coolant branch line 31 may be greater than a diameter of the second coolant line 11b. Because the diameters of the pipes are different, water resistances of the pipelines may be different. For example, the water resistance of the coolant branch line 31 may be less than the water resistance of the second coolant line 11b. Therefore, if the first coolant line 11a fluidically-communicates with both the second coolant line 11b and the coolant branch line 31, an amount of flow of the coolant flowing from the first coolant line 11a to the coolant branch line 31 may be greater than an amount of flow of the coolant flowing from the first coolant line 11a to the second coolant line 11b.

The chiller 32 may be disposed at the coolant branch line 31. The chiller 32 may be a water-cooled heat-exchanger. Additionally, the chiller 32 may be connected to the air conditioning device 20. Accordingly, the coolant of the coolant branch line 31 may pass through the chiller 32, and may exchange heat with a refrigerant from the air conditioning device 20 in the chiller 32. The coolant of the coolant branch line 31 may be cooled by dissipating heat through heat-exchange, and the cooled coolant may be used to cool the electric device 12. The refrigerant of the air conditioning device 20 may absorb heat to evaporate.

In an exemplary embodiment of the present disclosure, the air conditioning device 20 may include a compressor 22, a condenser 23, a second valve V2, an expansion valve EXV, and a heat-exchanger 24 sequentially connected through a refrigerant line 21. Additionally, the air conditioning device 20 may include a third valve V3, a fourth valve V4, a first refrigerant branch line 41, a second refrigerant branch line 42, a third refrigerant branch line 43, and a fourth refrigerant branch line 44.

For example, the refrigerant line 21 may include a first refrigerant line 21a, a second refrigerant line 21b, a third refrigerant line 21c, a fourth refrigerant line 21d, and a fifth refrigerant line 21e that are sequentially connected to each other. Two lines connected to each other among the first refrigerant line 21a, the second refrigerant line 21b, the third refrigerant line 21c, the fourth refrigerant line 21d, and the fifth refrigerant line 21e may directly fluidically-communicate with each other, or may indirectly fluidically-communicate with each other through one of the second valve V2, the third valve V3, and the fourth valve V4.

One end portion of the first refrigerant line 21a may be connected to an outlet of the compressor 22, and the other end portion of the first refrigerant line 21a may be connected to the second refrigerant line 21b. At the same time, the other end portion of the first refrigerant line 21a may be connected to the third refrigerant branch line 43. The first refrigerant line 21a may directly fluidically-communicate with the second refrigerant line 21b, and the third refrigerant branch line 43 may be branched from a connection portion between the first refrigerant line 21a and the second refrigerant line 21b.

One end portion of the second refrigerant line 21b may be connected to the other end portion of the first refrigerant line 21a, and the other end portion of the second refrigerant line 21b may be connected to the second valve V2. The condenser 23 may be disposed at the second refrigerant line 21b.

One end portion of the third refrigerant line 21c may be connected to the second valve V2, and the other end portion of the third refrigerant line 21c may be connected to the fourth valve V4. The second refrigerant line 21b and the third refrigerant line 21c may indirectly fluidically-communicate with each other through the second valve V2. The expansion valve EXV may be disposed at the third refrigerant line 21c.

One end portion of the fourth refrigerant line 21d may be connected to the fourth valve V4, and the other end portion of the fourth refrigerant line 21d may be connected to the third valve V3. The third refrigerant line 21c and the fourth refrigerant line 21d may indirectly fluidically-communicate with each other through the fourth valve V4. The heat-exchanger 24 may be disposed at the fourth refrigerant line 21d.

One end portion of the fifth refrigerant line 21e may be connected to the third valve V3, and the other end portion of the fifth refrigerant line 21e may be connected to an inlet of the compressor 22.

The compressor 22 may be an electric compressor that compresses the refrigerant into a high-temperature and high-pressure gaseous refrigerant. The refrigerant may circulate within the refrigerant line 21 and the first to fourth refrigerant branch lines 41 to 44 by operation of the compressor 22.

The condenser 23 may be an air-cooled condenser that is disposed at the front of the vehicle to condense the refrigerant within the condenser 23 using an outside air of the vehicle.

The second valve V2 may be a three-way valve, and may be disposed at the refrigerant line 21 between the condenser 23 and the expansion valve EXV. Three ports of the second valve V2 may be connected to the refrigerant line 21 and the first refrigerant branch line 41. For example, a first port of the second valve V2 may be connected to the other end portion of the second refrigerant line 21b downstream of the condenser 23. A second port of the second valve V2 may be connected to one end portion of the third refrigerant line 21c upstream of the expansion valve EXV. A third port of the second valve V2 may be connected to the first refrigerant branch line 41.

The second valve V2 may be configured for controlling flow of the refrigerant within the refrigerant line 21 and the first refrigerant branch line 41.

The expansion valve EXV may be an electronic expansion valve that selectively expands the refrigerant. The expansion valve EXV may be disposed upstream of each of the heat-exchanger 24 and the chiller 32 to selectively expand the refrigerant flowing into the heat-exchanger 24 and/or the chiller 32.

The heat-exchanger 24 may be disposed inside a Heating, Ventilation, and Air Conditioning (HVAC) module 25 of the air conditioning device 20. If the expansion valve EXV expands the refrigerant flowing into the heat-exchanger 24, the heat-exchanger 24 may be used as an evaporator that cools an air flowing into the vehicle. If the expansion valve EXV does not expand the refrigerant flowing into the heat-exchanger 24, the heat-exchanger 24 may be used as a condenser that heats the air flowing into the vehicle.

The third valve V3 may be a four-way valve, and may be disposed at the refrigerant line 21 between the heat-exchanger 24 and the compressor 22. For example, the third valve V3 may be disposed between the fourth refrigerant line 21d and the fifth refrigerant line 21e.

Four ports of the third valve V3 may be connected to the fourth refrigerant line 21d, the fifth refrigerant line 21e, the second refrigerant branch line 42, and the fourth refrigerant branch line 44. For example, a first port of the third valve V3 may be connected to the fourth refrigerant branch line 44. A second port of the third valve V3 may be connected to the other end portion of the fourth refrigerant line 21d downstream of the heat-exchanger 24. A third port of the third valve V3 may be connected to one end portion of the fifth refrigerant line 21e upstream of the compressor 22. A fourth port of the third valve V3 may be connected to the second refrigerant branch line 42 upstream of the chiller 32.

The fourth valve V4 may be a four-way valve, and may be disposed at the refrigerant line 21 between the expansion valve EXV and the heat-exchanger 24. For example, the fourth valve V4 may be disposed between the third refrigerant line 21c and the fourth refrigerant line 21d.

Four ports of the fourth valve V4 may be connected to the third refrigerant line 21c, the fourth refrigerant line 21d, the third refrigerant branch line 43, and the fourth refrigerant branch line 44. For example, a first port of the fourth valve V4 may be connected to the third refrigerant line 21c. A second port of the fourth valve V4 may be connected to the third refrigerant branch line 43. A third port of the fourth valve V4 may be connected to one end portion of the fourth refrigerant line 21d upstream of the heat-exchanger 24. A fourth port of the fourth valve V4 may be connected to the fourth refrigerant branch line 44.

The third valve V3 and the fourth valve V4 may be valves with a new structure, but a detailed description of a structure thereof will be omitted, and only a function thereof will be described. The present specification describes only a fluidical communication method of each port of the third valve V3 and each port of the fourth valve V4. Hereinafter, the fluidical communication method of each port of the third valve V3 and each port of the fourth valve V4 will be described in detail with reference to various operation modes of the thermal management system of the vehicle.

One end portion of the first refrigerant branch line 41 may be connected to the refrigerant line 21 downstream of the condenser 23 through the second valve V2, and the other end portion of the first refrigerant branch line 41 may be connected to the refrigerant line 21 downstream of the heat-exchanger 24. For example, the one end portion of the first refrigerant branch line 41 may be connected to the third port of the second valve V2, and the other end portion of the first refrigerant branch line 41 may be connected to the fourth refrigerant line 21d between the heat-exchanger 24 and the third valve V3.

One end portion of the second refrigerant branch line 42 may be connected to the third valve V3, and the other end portion of the second refrigerant branch line 42 may be connected to the refrigerant line 21 upstream of the compressor 22. For example, the one end portion of the second refrigerant branch line 42 may be connected to the fourth port of the third valve V3, and the other end portion of the second refrigerant branch line 42 may be connected to the fifth refrigerant line 21e between the third valve V3 and the compressor 22.

One end portion of the third refrigerant branch line 43 may be connected to the refrigerant line 21 downstream of the compressor 22, and the other end portion of the third refrigerant branch line 43 may be connected to the fourth valve V4. For example, the one end portion of the third refrigerant branch line 43 may be connected to a connection portion between the first refrigerant line 21a and the second refrigerant line 21b, and the other end portion of the third refrigerant branch line 43 may be connected to the second port of the fourth valve V4.

One end portion of the fourth refrigerant branch line 44 may be connected to the fourth valve V4, and the other end portion of the fourth refrigerant branch line 44 may be connected to the third valve V3. For example, the one end portion of the fourth refrigerant branch line 44 may be connected to the fourth port of the fourth valve V4, and the other end portion of the fourth refrigerant branch line 44 may be connected to the first port of the third valve V3.

The thermal management system of the vehicle may include a cooling fan 15. The cooling fan 15 may be disposed at the rear of each of the radiator 14 and the condenser 23. Therefore, the radiator 14 may cool the coolant within the second coolant line 11b using an outside air introduced through an operation of the cooling fan 15. The condenser 23 may condense the refrigerant within the second refrigerant line 21b using the outside air introduced through operation of the cooling fan 15.

Here, the front and rear direction may refer to a front and rear direction based on the vehicle.

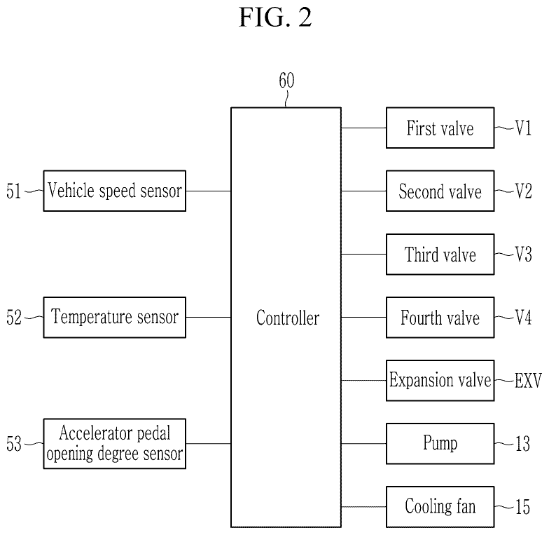

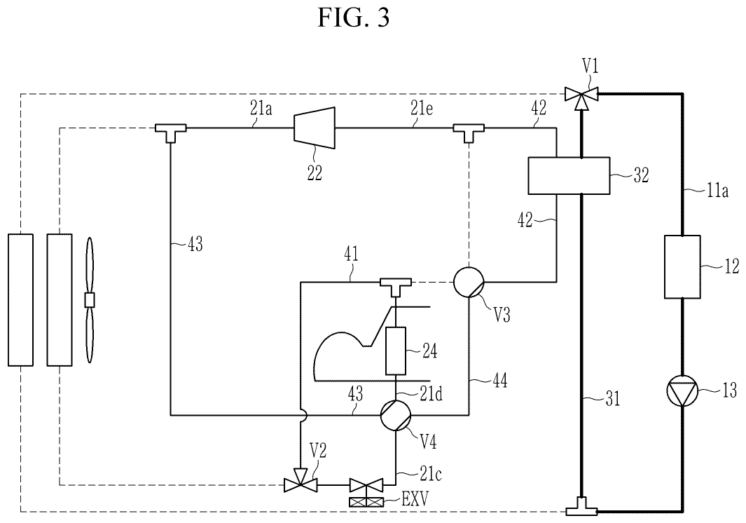

FIG. 2 is a block diagram illustrating the thermal management system of the vehicle according to an exemplary embodiment of the present disclosure.

The thermal management system of the vehicle may further include a vehicle speed sensor 51, a temperature sensor 52, and an accelerator pedal opening degree sensor 53. The vehicle speed sensor 51 may detect a vehicle speed (V). The temperature sensor 52 may be disposed at a motor to detect a motor temperature (T). The accelerator pedal opening degree sensor 53 may be disposed at an accelerator pedal, and may detect an accelerator pedal opening degree (a).

The thermal management system of the vehicle may further include a controller 60. The controller 60 including a processor may be configured to determine an operation mode of the thermal management system of the vehicle according to an operation mode of the air conditioning device 20, a driving mode of the vehicle, the motor temperature (T) detected by the temperature sensor 52, and the accelerator pedal opening degree (a) detected by the accelerator pedal opening degree sensor 53. If the operation mode of the thermal management system of the vehicle is determined, the controller 60 may be configured for controlling operations of the first valve V1, the second valve V2, the third valve V3, the fourth valve V4, and the expansion valve EXV, and may be configured for controlling operations of the compressor 22, the pump 13, and the cooling fan 15.

For example, the controller 60 may be configured for controlling the operations of the first valve V1, the second valve V2, the third valve V3, the fourth valve V4, and the expansion valve EXV according to the determined operation mode of the thermal management system of the vehicle. Additionally, the controller 60 may be configured for controlling the operations of the pump 13 and the cooling fan 15 according to the driving mode of the vehicle, the motor temperature (T), the vehicle speed (V), and the accelerator pedal opening degree (a) (e.g., the controller 60 may be configured for controlling a rotation speed of the pump 13 and a duty cycle of the cooling fan 15 according to the driving mode of the vehicle, the motor temperature (T), the vehicle speed (V), and the accelerator pedal opening degree (a)). Hereinafter, control executed by the controller 60 will be described in detail with reference to each operation mode of the thermal management system of the vehicle.

In an exemplary embodiment of the present disclosure, if the motor temperature (T) is lower than a first predetermined temperature (T1) and the accelerator pedal opening degree (α) is smaller than a first predetermined opening degree (α1) in a case in which the operation mode of the air conditioning device 20 is a vehicle interior heating mode, the controller 60 may be configured to determine the operation mode of the thermal management system of the vehicle as a first mode. If the motor temperature (T) is greater than or equal to the first predetermined temperature (T1) or the accelerator pedal opening degree (α) is greater than or equal to the first predetermined opening degree (α1), the controller 60 may be configured to determine the operation mode of the thermal management system of the vehicle as a second mode.

The driving mode of the vehicle may include a first driving mode for energy saving (also referred to as an “Economical mode”), a second driving mode for general driving (also referred to as a “NORMAL mode”), a third driving mode for sports (also referred to as a “Sports mode”), a fourth driving mode for driving on a slippery road (also referred to as a “Snow mode”), and a fifth driving mode for experiencing general high performance driving of the vehicle (also referred to as a “General performance mode”). Additionally, the driving mode of the vehicle may include a sixth driving mode for experiencing super high performance driving of the vehicle (also referred to as a “Super performance mode”) and a seventh driving mode for driving after collision of the vehicle occurs (also referred to as a “Safety mode”). However, an exemplary embodiment of the present disclosure is not limited thereto, and driving modes of the vehicle may include more or fewer driving modes.

The first predetermined temperature (T1) and the first predetermined opening degree (α1) may be determined as values according to the driving modes of the vehicle other than the sixth driving mode and the seventh driving mode (i.e., the first to fifth driving modes). Table 1 below may show a mapping relationship between the first predetermined temperature T1, the first predetermined degree (α1), and other driving modes other than the sixth driving mode and the seventh driving mode (i.e., the first to fifth driving modes).

TABLE 1

| Driving mode | T1 | α1 |
|---|---|---|
| First driving mode | 80 | 70 |
| Second driving mode | 80 | 70 |
| Third driving mode | 60 | 40 |
| Fourth driving mode | 80 | 70 |
| Fifth driving mode | 50 | 40 |

A unit of the motor temperature (T) may be° C., and a unit of the accelerator pedal opening degree (α) may be %. That the accelerator pedal opening degree (α) is 70% may mean that the accelerator pedal opening degree is 70% of a maximum opening degree.

Table 1 only exemplarily shows the mapping relationship between the first predetermined temperature (T1), the first predetermined opening degree (α1), and the driving modes of the vehicle (i.e., the first to the fifth driving modes), but an exemplary embodiment of the present disclosure is not limited thereto, and the values of Table 1 may be changed as necessary.

If the motor temperature (T) is lower than a second predetermined temperature (T2) and the accelerator pedal opening degree (α) is lower than a second predetermined opening degree (α2) in a case in which the operation mode of the air conditioning device 20 is a vehicle internal cooling mode, the controller 60 may be configured to determine the operation mode of the thermal management system of the vehicle as a third mode. If the motor temperature (T) is greater than or equal to the second predetermined temperature (T2) or the accelerator pedal opening degree (α) is greater than or equal to the second predetermined opening degree (α2), the controller 60 may be configured to determine the operation mode of the thermal management system of the vehicle as a fourth mode.

The second predetermined temperature (T2) and the second predetermined opening degree (α2) may be determined as values according to the driving modes other than the sixth driving mode and the seventh driving mode (i.e., the first to fifth driving modes). Table 2 below may show a mapping relationship between the second predetermined temperature (T2), the second predetermined opening degree (α2), and the driving modes of the vehicle (i.e., the first to fifth driving modes).

TABLE 2

| Driving mode | T2 | α2 |
|---|---|---|
| First driving mode | 100 | 100 |
| Second driving mode | 100 | 100 |
| Third driving mode | 60 | 70 |
| Fourth driving mode | 100 | 100 |
| Fifth driving mode | 40 | 60 |

Table 2 only exemplarily shows the mapping relationship between the second predetermined temperature (T2), the second predetermined opening degree (α2), and the driving modes of the vehicle (i.e., the first to the fifth driving modes), but an exemplary embodiment of the present disclosure is not limited thereto, and the values of Table 2 may be changed as necessary.

If the motor temperature T is greater than or equal to the second predetermined temperature T2 or the accelerator pedal degree (α) is greater than or equal to the second predetermined opening degree (α2) in a case in which the air conditioning device is not operated (i.e., in a case in which the air conditioning device does not execute the heating mode and does not execute the cooling mode), the controller 60 may be configured to determine the operation mode of the thermal management system of the vehicle as a fifth mode.

Additionally, if the driving mode of the vehicle is the sixth driving mode, the controller 60 may be configured to determine the operation mode of the thermal management system of the vehicle as a sixth mode. If the driving mode of the vehicle is the seventh driving mode, the controller 60 may be configured to determine the operation mode of the thermal management system of the vehicle as a seventh mode.

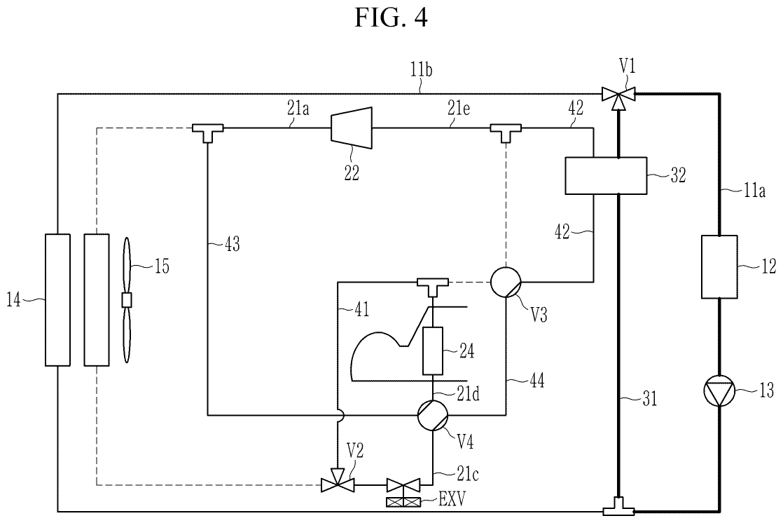

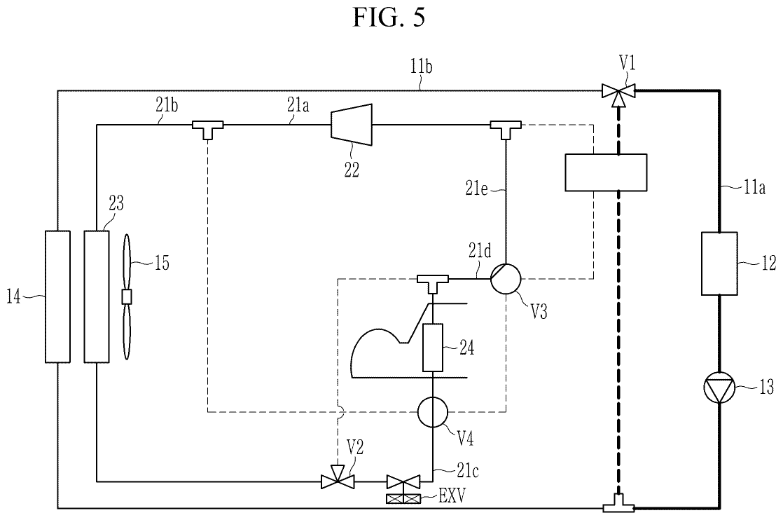

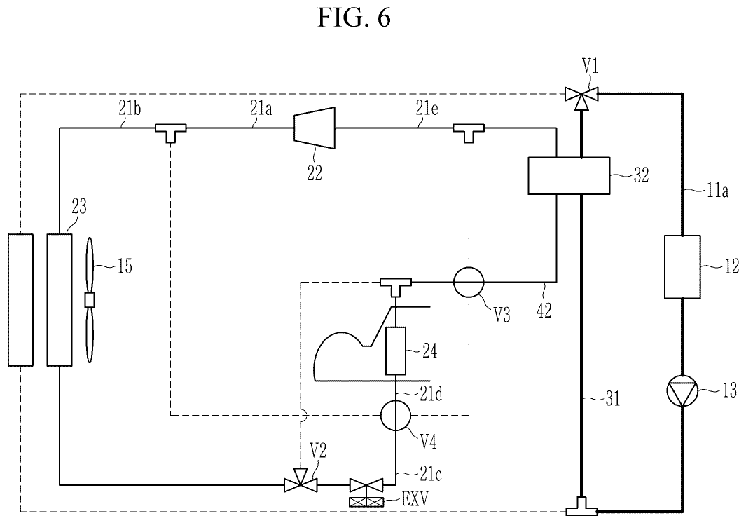

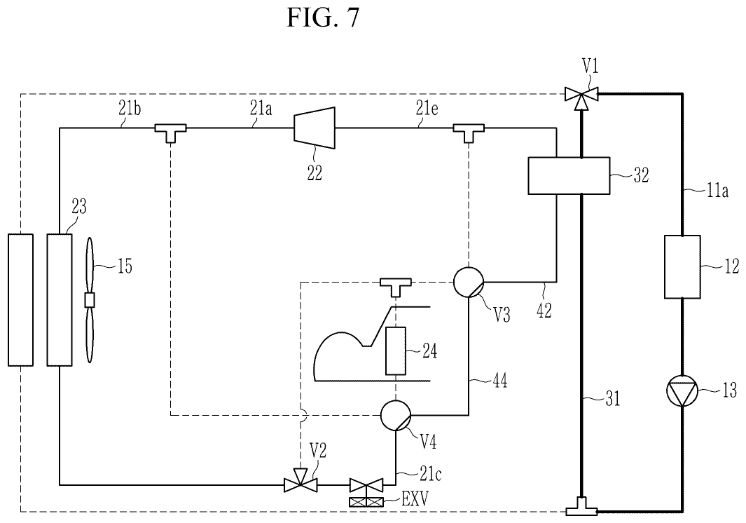

FIG. 3 is a schematic diagram illustrating the first mode of the thermal management system of the vehicle according to an exemplary embodiment of the present disclosure, FIG. 4 is a schematic diagram illustrating the second mode of the thermal management system of the vehicle according to an exemplary embodiment of the present disclosure, FIG. 5 is a schematic diagram illustrating the third mode of the thermal management system of the vehicle according to an exemplary embodiment of the present disclosure, FIG. 6 is a schematic diagram illustrating the fourth mode of the thermal management system of the vehicle according to an exemplary embodiment of the present disclosure, and FIG. 7 is a schematic diagram illustrating the fifth mode, the sixth mode, and the seventh mode of the thermal management system of the vehicle according to an exemplary embodiment of the present disclosure. Hereinafter, each operation mode of the thermal management system of the vehicle will be described in detail with reference to FIG. 3, FIG. 4, FIG. 5, FIG. 6, and FIG. 7.

As shown in FIG. 3, in the first mode, the controller 60 may be configured for controlling the first valve V1 to close the first port of the first valve V1 and open the second port and the third port of the first valve V1 in the cooling device 10. Accordingly, the first coolant line 11a may fluidically-communicate with the coolant branch line 31, and the second coolant line 11b may be blocked to form a loop for circulation of the coolant.

In the loop for the circulation of the coolant, the coolant flowing out from the electric device 12 may flow into the pump 13, the coolant flowing out from the pump 13 may flow into the chiller 32 through the coolant branch line 31, and the coolant flowing out from the chiller 32 may flow into the electric device 12 again through the first coolant line 11a.

Therefore, through an operation of the first valve V1, the coolant whose temperature rises while it passes through the electric device 12 may flow into the coolant branch line 31 without passing through the radiator 14.

The controller 60 may be configured for controlling the pump 13 to be operated.

The controller 60 may be configured for controlling the second valve V2 to close the first port of the second valve V2 and open the second port and the third port of the second valve V2 in the air conditioning device 20. Accordingly, the first refrigerant branch line 41 may fluidically-communicate with the third refrigerant line 21c, and the second refrigerant line 21b may be blocked.

The controller 60 may be configured for controlling the third valve V3 to fluidically-communicate the first port of the third valve V3 with the fourth port of the third valve V3 and close the second port and the third port of the third valve V3. Accordingly, the fourth refrigerant branch line 44 may fluidically-communicate with the second refrigerant branch line 42, and a portion of the fourth refrigerant line 21d and a portion of the fifth refrigerant line 21e may be blocked.

The controller 60 may be configured for controlling the fourth valve V4 to fluidically-communicate the first port of the fourth valve V4 with the fourth port of the fourth valve V4 and fluidically-communicate the second port of the fourth valve V4 with the third port of the fourth valve V4. Accordingly, the third refrigerant branch line 43 may fluidically-communicate with the fourth refrigerant line 21d, and the third refrigerant line 21c may fluidically-communicate with the fourth refrigerant branch line 44.

Accordingly, the first refrigerant line 21a, the third refrigerant branch line 43, the fourth refrigerant line 21d, the first refrigerant branch line 41, the third refrigerant line 21c, the fourth refrigerant branch line 44, the second refrigerant branch line 42, and the fifth refrigerant line 21e may sequentially fluidically-communicate with each other to form a loop for circulation of the refrigerant.

In the loop for the circulation of the refrigerant, the refrigerant flowing out from the compressor 22 may flow into the heat-exchanger 24, the refrigerant flowing out from the heat-exchanger 24 may flow into the chiller 32, and the refrigerant flowing out from the chiller 32 may flow into the compressor 22 again.

The controller 60 may be configured for controlling the compressor 22 to be operated, and may be configured for controlling the expansion valve EXV to expand the refrigerant flowing into the chiller 32. In the instant case, the chiller 32 may be used as an evaporator, and the heat-exchanger 24 may be used as a condenser.

There may be heat-exchange between the loop for the circulation of the coolant and the loop for the circulation of the refrigerant. The coolant whose temperature rises while it passes through the electric device 12 may evaporate the refrigerant by exchanging heat with the expanded refrigerant within the second refrigerant branch line 42 in the chiller 32. Therefore, waste heat generated by the electric device 12 may be recovered using the chiller 32.

At the same time, an air introduced into the vehicle may be heated by the refrigerant within the heat-exchanger 24 while passing through the heat-exchanger 24 configured as the condenser to realize heating of the vehicle cabin.

The controller 60 may be configured to determine a rotation speed (EWP) of the pump 13 according to the driving mode of the vehicle (i.e., one of the first to fifth driving modes) and the motor temperature (T). The controller 60 may be configured for controlling the pump 13 to be operated in response thereto.

Table 3 below may show a mapping relationship between the rotation speed (EWP) of the pump 13, the driving modes of the vehicle (i.e., the first to the fifth driving modes), and the motor temperature (T).

TABLE 3

| Driving | T | | | | | | | | |
|---|---|---|---|---|---|---|---|---|---|
| mode | 20 | 30 | 40 | 50 | 60 | 70 | 80 | 90 | 120 |
| First | 1000 | 1000 | 1500 | 1500 | 2000 | 2000 | 2500 | 2500 | 3600 |
| driving | | | | | | | | | |
| mode | | | | | | | | | |
| Second | 1000 | 1000 | 1500 | 1500 | 2000 | 2000 | 2500 | 2500 | 3600 |
| driving | | | | | | | | | |
| mode | | | | | | | | | |
| Third | 1000 | 1500 | 1500 | 2000 | 2500 | 3000 | 3600 | 3600 | 3600 |
| driving | | | | | | | | | |
| mode | | | | | | | | | |
| Fourth | 1000 | 1000 | 1500 | 1500 | 2000 | 2000 | 2500 | 2500 | 3600 |
| driving | | | | | | | | | |
| mode | | | | | | | | | |
| Fifth | 1500 | 2000 | 2000 | 2500 | 3000 | 3600 | 3600 | 3600 | 3600 |
| driving | | | | | | | | | |
| mode | | | | | | | | | |

A unit of the rotation speed (EWP) of the pump 13 may be rpm. Table 3 only exemplarily shows the mapping relationship between the rotation speed (EWP) of the pump 13, the driving modes of the vehicle (i.e., the first to the fifth driving modes), and the motor temperature (T), but an exemplary embodiment of the present disclosure is not limited thereto, and values of Table 3 may be changed as necessary.

If the interior of the vehicle needs to be heated through the first mode configured as described above, the waste heat generated by the electric device 12 may be recovered to heat the interior of the vehicle so that it is possible to reduce use of an electric heater and extend a driving distance of an electric vehicle.

As shown in FIG. 4, in the second mode, the controller 60 may be configured for controlling the first valve V1 to open the first port, the second port, and the third port of the first valve V1 in the cooling device 10. Accordingly, the first coolant line 11a may fluidically-communicate with the second coolant line 11b, and the first coolant line 11a may fluidically-communicate with the coolant branch line 31 to form a loop for circulation of the coolant.

In the loop for the circulation of the coolant, the coolant flowing out from the electric device 12 may flow into the pump 13, a portion of the coolant flowing out from the pump 13 may flow into the chiller 32 through the coolant branch line 31, and the remaining portion of the coolant may flow into the radiator 14 through the second coolant line 11b. The coolant flowing out from the chiller 32 and the coolant flowing out from the radiator 14 may be joined at the first valve V1, and may flow into the electric device 12 again through the first coolant line 11a.

Therefore, through an operation of the first valve V1, a portion of the coolant whose temperature rises while it passes through the electric device 12 may flow into the coolant branch line 31, the remaining portion of the coolant may flow into the second coolant line 11b, and may pass through the radiator 14.

The controller 60 may be configured for controlling the pump 13 to be operated.

In the air conditioning device 20, the controller 60 may be configured for controlling the second valve V2 to close the first port of the second valve V2 and open the second port and the third port of the second valve V2. Accordingly, the first refrigerant branch line 41 may fluidically-communicate with the third refrigerant line 21c, and the second refrigerant line 21b may be blocked.

The controller 60 may be configured for controlling the third valve V3 to fluidically-communicate the first port of the third valve V3 with the fourth port of the third valve V3 and close the second port and the third port of the third valve V3. Accordingly, the fourth refrigerant branch line 44 may fluidically-communicate with the second refrigerant branch line 42, and a portion of the fourth refrigerant line 21d and a portion of the fifth refrigerant line 21e may be blocked.

The controller 60 may be configured for controlling the fourth valve V4 to fluidically-communicate the first port of the fourth valve V4 with the fourth port of the fourth valve V4 and fluidically-communicate the second port of the fourth valve V4 with the third port of the fourth valve V4. Accordingly, the third refrigerant branch line 43 may fluidically-communicate with the fourth refrigerant line 21d, and the third refrigerant line 21c may fluidically-communicate with the fourth refrigerant branch line 44.

Accordingly, the first refrigerant line 21a, the third refrigerant branch line 43, the fourth refrigerant line 21d, the first refrigerant branch line 41, the third refrigerant line 21c, the fourth refrigerant branch line 44, the second refrigerant branch line 42, and the fifth refrigerant line 21e may sequentially fluidically-communicate with each other to form a loop for circulation of the refrigerant.

In the loop for the circulation of the refrigerant, the refrigerant flowing out from the compressor 22 may flow into the heat-exchanger 24, the refrigerant flowing out from the heat-exchanger 24 may flow into the chiller 32, and the refrigerant flowing out from the chiller 32 may flow into the compressor 22 again.

The controller 60 may be configured for controlling the compressor 22 to be operated, and may be configured for controlling the expansion valve EXV to expand the refrigerant flowing into the chiller 32. In the instant case, the chiller 32 may be used as an evaporator, and the heat-exchanger 24 may be used as a condenser.

There may be heat-exchange between the loop for the circulation of the coolant and the loop for the circulation of the refrigerant. A portion of the coolant whose temperature rises while it passes through the electric device 12 may evaporate the refrigerant by exchanging heat with the expanded refrigerant within the second refrigerant branch line 42 in the chiller 32. Therefore, waste heat generated by the electric device 12 may be recovered using the chiller 32.

At the same time, the remaining portion of the coolant whose temperature rises while it passes through the electric device 12 may cool the coolant by exchanging heat with an outside air of the vehicle within the radiator 14, and the cooled coolant may cool the electric device 12 while passing through the electric device 12 again. Therefore, the electric device 12 may be separately cooled using the radiator 14. An air introduced into the vehicle may be heated by the refrigerant within the heat-exchanger 24 while passing through the heat-exchanger 24 that is the condenser to realize heating of the vehicle cabin.

The controller 60 may be configured to determine a rotation speed (EWP) of the pump 13, and may be configured for controlling the pump 13 to be operated in the same manner as the first mode. Here, a redundant description is omitted.

A duty cycle (DUTY) of the cooling fan 15 and the motor temperature (T) may include a mapping relationship, and the duty cycle (DUTY) of the cooling fan 15 and the accelerator pedal opening degree (α) may also include a mapping relationship. The controller 60 may be configured to determine the duty cycle (DUTY) of the cooling fan 15 according to one of the motor temperature (T) and the accelerator pedal opening degree (α). For example, the controller 60 may compare the duty cycle (DUTY_{T}) of the cooling fan 15 corresponding to the motor temperature (T) with a duty cycle (DUTY_{α}) of the cooling fan 15 corresponding to the accelerator pedal opening degree (α) to determine a larger value among the duty cycle (DUTY_{T}) and the duty cycle (DUTY_{α}). The controller 60 may be configured to determine the determined larger value among the duty cycle (DUTY_{T}) and the duty cycle (DUTY_{α}) as the duty cycle (DUTY) for controlling an operation of the cooling fan 15, and may be configured for controlling the cooling fan 15 to be operated in response thereto.

For example, if the duty cycle (DUTY_{T}) of the cooling fan 15 corresponding to the motor temperature (T) is greater than the duty cycle (DUTY_{α}) of the cooling fan 15 corresponding to the accelerator pedal opening degree (α), the controller 60 may be configured to determine the duty cycle (DUTY_{T}) of the cooling fan 15 corresponding to the motor temperature (T) as the duty cycle (DUTY) for controlling the operation of the cooling fan 15.

Table 4 below may show a mapping relationship between the duty cycle (DUTY) of the cooling fan 15, the driving mode of the vehicle (i.e., one of the first to fifth driving modes), and a motor temperature (T′).

TABLE 4

| Driving | T′ | | | | | | | | | | |
|---|---|---|---|---|---|---|---|---|---|---|---|
| mode | 50 | 60 | 70 | 80 | 90 | 100 | 110 | 120 | 130 | 140 | 150 |
| First | 0 | 0 | 0 | 0 | 0 | 20 | 30 | 30 | 50 | 70 | 90 |
| driving | | | | | | | | | | | |
| mode | | | | | | | | | | | |
| Second | 0 | 0 | 0 | 0 | 0 | 20 | 30 | 30 | 50 | 70 | 90 |
| driving | | | | | | | | | | | |
| mode | | | | | | | | | | | |
| Third | 0 | 20 | 20 | 30 | 40 | 50 | 60 | 70 | 80 | 90 | 90 |
| driving | | | | | | | | | | | |
| mode | | | | | | | | | | | |
| Fourth | 0 | 0 | 0 | 0 | 0 | 20 | 30 | 30 | 50 | 70 | 90 |
| driving | | | | | | | | | | | |
| mode | | | | | | | | | | | |
| Fifth | 65 | 80 | 90 | 90 | 90 | 90 | 90 | 90 | 90 | 90 | 90 |
| driving | | | | | | | | | | | |
| mode | | | | | | | | | | | |

Here, the motor temperature (T′) may refer to a motor temperature obtained after modifying of an actual motor temperature (T). The actual motor temperature (T) may refer to a motor temperature detected through the temperature sensor 52. A reason for modifying the actual motor temperature (T) is that the motor is expected to be rapidly heated in a short time period because electric power output of the motor is increased when the vehicle speed (V) is high and the electric power output is increased even if a current actual motor temperature (T) is not high. To prevent the motor from being rapidly heated in the short time period, the motor may be pre-cooled. Here, the pre-cooling may mean operating the cooling fan 15 with the duty cycle (DUTY_{T}) higher than that of the cooling fan 15 corresponding to the actual motor temperature (T) to cool the motor in advance before the motor rapidly raises its temperature. That is, the cooling fan 15 may be operated with the duty cycle (DUTY) higher than that currently required for cooling of the motor so that the motor is cooled in advance. Thus, it is possible to prevent the motor from rapidly raising its temperature within a short time period.

For example, the controller 60 may be configured to determine the motor temperature (T′) after modification using Equation 1 below according to the current actual motor temperature (T) and the vehicle speed (V).

$${T}^{′} = T + k \times A \qquad Equation 1$$

Here, k may be a constant coefficient, and A may be a predetermined value determined by the vehicle speed (V). Hereinafter, a case in which k is 10 is referred to as an exemplary embodiment of the present disclosure, but an exemplary embodiment of the present disclosure is not limited thereto, and k may be another value.

A predetermined value (A) may be determined based on the vehicle speed (V). For example, if the vehicle speed (V) is within a first speed range, the predetermined value (A) may be 0. For example, the first speed range may be greater than 0 and less than or equal to 40 kph. If the vehicle speed (V) is within a second speed range, the predetermined value (A) may be 1. For example, the second speed range may be greater than 40 kph and less than or equal to 80 kph. If the vehicle speed (V) is within a third speed range, the predetermined value (A) may be 2. For example, the third speed range may be greater than 80 kph.

For example, a case in which the motor temperature (T′) after modification is 120° C. may include a case where the vehicle speed (V) is greater than 0 and less than or equal to 40 kph (i.e., the predetermined value (A) is 0) and the actual motor temperature (T) is 120° C., a case where the vehicle speed (V) is greater than 40 kph and less than or equal to 80 kph (i.e., the predetermined value (A) is 1) and the actual motor temperature (T) is 110° C., and a case where the vehicle speed (V) is greater than 80 kph (i.e., the predetermined value (A) is 2) and the actual motor temperature (T) is 100° C. In the three situations described above, if the driving mode is the first driving mode, it may be determined that the duty cycle (DUTY_{T}) of the cooling fan 15 corresponding to the motor temperature (T′) after modification is 30 based on Table 4.

As an exemplary embodiment of the present disclosure, a case in which the motor temperature (T′) after modification is 140° C. may include a case where the vehicle speed (V) is greater than 0 and less than or equal to 40 kph (i.e., the predetermined value (A) is 0) and the actual motor temperature (T) is 140° C., a case where the vehicle speed (V) is greater than 40 kph and less than or equal to 80 kph (i.e., the predetermined value (A) is 1) and the actual motor temperature (T) is 130° C., and a case where the vehicle speed (V) is greater than 80 kph (i.e., the predetermined value (A) is 2) and the actual motor temperature (T) is 120° C. In the three situations described above, if the driving mode is the fourth driving mode, it may be determined that the duty cycle (DUTY_{T}) of the cooling fan 15 corresponding to the motor temperature (T′) after modification is 70 based on Table 4.

That is, the duty cycle of the cooling fan 15 when the actual motor temperature (T) is predetermined but the vehicle speed (V) is high may be the same as the duty cycle of the cooling fan 15 when the actual motor temperature (T) is high but the vehicle speed (V) is low. A conventional vehicle thermal management system is configured to control a duty cycle of the cooling fan 15 by considering only the actual motor temperature (T) without considering the vehicle speed (V). However, the thermal management system of the vehicle according to an exemplary embodiment of the present disclosure may consider not only the actual motor temperature (T) but also the vehicle speed (V) when an operation of the cooling fan 15 is controlled.

Table 4 only exemplarily shows the mapping relationship between the duty cycle (DUTY) of the cooling fan 15, the driving mode of the vehicle (i.e., one of the first to fifth driving modes), and the motor temperature (T′) after modification, but an exemplary embodiment of the present disclosure is not limited thereto, and values of Table 4 may be changed as necessary.

Conversely, if the duty cycle (DUTY_{α}) of the cooling fan 15 corresponding to the accelerator pedal opening degree (α) is greater than the duty cycle (DUTY_{T}) of the cooling fan 15 corresponding to the motor temperature (T′) after modification, the controller 60 may be configured to determine the duty cycle (DUTY_{α}) of the cooling fan 15 corresponding to the accelerator pedal opening degree (α) as the duty cycle (DUTY) for controlling the operation of the cooling fan 15.

Table 5 below may show a mapping relationship between the duty cycle (DUTY) of the cooling fan 15, the driving mode of the vehicle (i.e., one of the first to fifth driving modes), and the accelerator pedal opening degree (α).

TABLE 5

| | α | | | | | | |
|---|---|---|---|---|---|---|---|
| Driving mode | 40 | 50 | 60 | 70 | 80 | 90 | 100 |
| First driving mode | 0 | 0 | 0 | 0 | 0 | 0 | 0 |
| Second driving mode | 0 | 0 | 0 | 0 | 0 | 0 | 0 |
| Third driving mode | 0 | 0 | 30 | 40 | 60 | 80 | 100 |
| Fourth driving mode | 0 | 0 | 0 | 0 | 0 | 0 | 0 |
| Fifth driving mode | 50 | 65 | 80 | 100 | 100 | 100 | 100 |

For example, if the accelerator pedal opening degree (α) is 70% in a case in which the driving mode is the third driving mode, it may be determined that the duty cycle (DUTY_{α}) of the cooling fan 15 corresponding to the accelerator pedal opening degree (α) is 40 based on Table 5. As an exemplary embodiment of the present disclosure, if the accelerator pedal opening degree (α) is 60% in a case in which the driving mode is the fifth driving mode, it may be determined that the duty cycle (DUTY_{α}) of the cooling fan 15 corresponding to the accelerator pedal opening degree (α) is 80 based on Table 5.

For example, if the motor temperature (T′) after modification is 120° C. and the accelerator pedal opening degree (α) is 80% in a case in which the vehicle is driven in the third driving mode, based on Tables 4 and 5 above, the controller 60 may be configured to determine the duty cycle (DUTY_{T}) of the cooling fan 15 corresponding to the motor temperature (T′) after modification as 70, and may be configured to determine the duty cycle (DUTY_{α}) of the cooling fan 15 corresponding to the accelerator pedal opening degree (α) as 60. Because the duty cycle (DUTY_{T}) is greater than the duty cycle (DUTY_{α}), the controller 60 may be configured to determine the duty cycle (DUTY_{T}) of the cooling fan 15 corresponding to the motor temperature (T′) after modification as the duty cycle (DUTY) for controlling the operation of the cooling fan 15.

If the duty cycle (DUTY_{T}) of the cooling fan 15 corresponding to the motor temperature (T′) after modification and the duty cycle (DUTY_{α}) of the cooling fan 15 corresponding to the accelerator pedal opening degree (α) are the same (i.e., if the duty cycle (DUTY_{T}) is the same as the duty cycle (DUTY_{α}), the controller 60 may be configured to determine one of the duty cycle (DUTY_{T}) and the duty cycle (DUTY_{α}) as the duty cycle (DUTY) for controlling the operation of the cooling fan 15.

For example, if the vehicle is driven in the third driving mode, the motor temperature (T′) after modification is 110° C., and the accelerator pedal opening degree (α) is 80%, based on Tables 4 and 5 above, the controller 60 may be configured to determine the duty cycle (DUTY_{T}) of the cooling fan 15 corresponding to the motor temperature (T′) after modification as 60, and may be configured to determine the duty cycle (DUTY_{α}) of the cooling fan 15 corresponding to the accelerator pedal opening degree (α) as 60.

Because the duty cycle (DUTY_{T}) and the duty cycle (DUTY_{α}) are the same, the controller 60 may be configured to determine one of the duty cycle (DUTY_{T}) and the duty cycle (DUTY_{α}) as the duty cycle (DUTY) for controlling the operation of the cooling fan 15 that is 60.

Therefore, when the duty cycle (DUTY) of the cooling fan 15 is determined, the controller 60 may receive the actual motor temperature (T) detected from the temperature sensor 52. The controller 60 may receive the vehicle speed (V) detected from the vehicle speed sensor 51, and may be configured to determine the predetermined value (A) according to the vehicle speed (V). The controller 60 may be configured to determine the motor temperature (T′) after modification using Equation 1 according to the received actual motor temperature (T) and the determined predetermined value (A). In in accordance with the driving mode of the vehicle (e.g., one of the first to fifth driving modes) and the motor temperature (T′) after modification, the controller 60 may be configured to determine the duty cycle (DUTY_{T}) of the cooling fan 15 corresponding to the motor temperature (T′) after modification based on Table 4. Additionally, the controller 60 may receive the accelerator pedal opening degree (α) detected from the accelerator pedal opening degree sensor 53. In in accordance with the driving mode of the vehicle (e.g., one of the first to fifth driving modes) and the accelerator pedal opening degree (α), the controller 60 may be configured to determine the duty cycle (DUTY) of the cooling fan 15 corresponding to the accelerator pedal opening degree (α) based on Table 5. The controller 60 may compare the duty cycle (DUTY_{T}) of the cooling fan 15 corresponding to the motor temperature (T′) after modification with the duty cycle (DUTY_{α}) of the cooling fan 15 corresponding to the accelerator pedal opening degree (α) to determine a larger value among the duty cycle (DUTY_{T}) and the duty cycle (DUTY_{α}). The controller 60 may be configured to determine the larger value among the duty cycle (DUTY_{T}) and the duty cycle (DUTY_{α}) as the duty cycle (DUTY) for controlling the operation of the cooling fan 15. If the duty cycle (DUTY_{T}) and the duty cycle (DUTY_{α}) are the same, the controller 60 may be configured to determine one of the duty cycle (DUTY_{T}) and the duty cycle (DUTY_{α}) as the duty cycle (DUTY) for controlling the operation of the cooling fan 15.

If a temperature of the electric device 12 is too high through the second mode configured as described above, the waste heat generated by the electric device 12 may be recovered to be used to heat the interior of the vehicle, and at the same time, the electric device 12 may be cooled using the radiator 14.

As shown in FIG. 5, in the third mode, the controller 60 may be configured for controlling the first valve V1 to open the first port and the second port of the first valve V1 and close the third port of the first valve V1 in the cooling device 10. Accordingly, the first coolant line 11a may fluidically-communicate with the second coolant line 11b, and the coolant branch line 31 may be blocked to form a loop for circulation of the coolant.

In the loop for the circulation of the coolant, the coolant flowing out from the electric device 12 may flow into the pump 13, the coolant flowing out from the pump 13 may flow into the radiator 14 through the second coolant line 11b, and the coolant flowing out from the radiator 14 may flow into the electric device 12 again through the first coolant line 11a.

Therefore, through an operation of the first valve V1, the coolant whose temperature rises while it passes through the electric device 12 may flow into the second coolant line 11b to pass through the radiator 14.

The controller 60 may be configured for controlling the pump 13 to be operated.

In the air conditioning device 20, the controller 60 may be configured for controlling the second valve V2 to open the first port and the second port of the second valve V2 and close the third port of the second valve V2. Accordingly, the second refrigerant line 21b may fluidically-communicate with the third refrigerant line 21c, and the first refrigerant branch line 41 may be blocked.

The controller 60 may be configured for controlling the third valve V3 to close the first port and the fourth port of the third valve V3, and may fluidically-communicate the second port of the third valve V3 with the third port of the third valve V3. Accordingly, the fourth refrigerant line 21d may fluidically-communicate with the fifth refrigerant line 21e, and the fourth refrigerant branch line 44 and the second refrigerant branch line 42 may be blocked.

The controller 60 may be configured for controlling the fourth valve V4 to fluidically-communicate the first port of the fourth valve V4 with the third port of the fourth valve V4 and close the second port and the fourth port of the fourth valve V4. Accordingly, the third refrigerant line 21c may fluidically-communicate with the fourth refrigerant line 21d, and the third refrigerant branch line 43 and the fourth refrigerant branch line 44 may be blocked.

Accordingly, the first refrigerant line 21a, the second refrigerant line 21b, the third refrigerant line 21c, the fourth refrigerant line 21d, and the fifth refrigerant line 21e may sequentially fluidically-communicate with each other to form a loop for circulation of the refrigerant.

In the loop for the circulation of the refrigerant, the refrigerant flowing out from the compressor 22 may flow into the condenser 23, the refrigerant flowing out from the condenser 23 may flow into the heat-exchanger 24, and the refrigerant flowing out from the heat-exchanger 24 may flow into the compressor 22 again.

The controller 60 may be configured for controlling the compressor 22 to be operated, and may be configured for controlling the expansion valve EXV to expand the refrigerant flowing into the heat-exchanger 24. In the instant case, the heat-exchanger 24 may be used as an evaporator.

There may be no heat-exchange between the loop for the circulation of the coolant and the loop for the circulation of the refrigerant.

The coolant whose temperature rises while it passes through the electric device 12 may cool the coolant by exchanging heat with an outside air of the vehicle within the radiator 14, and the cooled coolant may cool the electric device 12 while passing through the electric device 12 again. Therefore, the electric device 12 may be cooled using the radiator 14. An air introduced into the vehicle may be cooled by the refrigerant within the heat-exchanger 24 while passing through the heat-exchanger 24 configured as the evaporator to realize cooling of the vehicle cabin.

The controller 60 may be configured to determine a rotation speed (EWP) of the pump 13, and may be configured for controlling the pump 13 to be operated in the same manner as the first mode. Here, a redundant description is omitted.

Additionally, the controller 60 may be configured to determine the duty cycle (DUTY) of the cooling fan 15 in the same manner as the second mode, and may be configured for controlling the cooling fan 15 to be operated. Here, a redundant description is omitted.

If a temperature of the electric device 12 is not too high in a case in which the interior of the vehicle needs to be cooled and the electric device 12 needs to be cooled through the third mode configured as described above, the electric device 12 may be cooled using the radiator 14 without using the chiller 32.

As shown in FIG. 6, in the fourth mode, the controller 60 may be configured for controlling the first valve V1 to close the first port of the first valve V1 and open the second port and the third port of the first valve V1 in the cooling device 10. Accordingly, the first coolant line 11a may fluidically-communicate with the coolant branch line 31, and the second coolant line 11b may be blocked to form a loop for circulation of the coolant.

In the loop for the circulation of the coolant, the coolant flowing out from the electric device 12 may flow into the pump 13, the coolant flowing out from the pump 13 may flow into the chiller 32 through the coolant branch line 31, and the coolant flowing out from the chiller 32 may flow into the electric device 12 again through the first coolant line 11a.

Therefore, through an operation of the first valve V1, the coolant whose temperature rises while it passes through the electric device 12 may flow into the coolant branch line 31 without passing through the radiator 14.

The controller 60 may be configured for controlling the pump 13 to be operated.

The controller 60 may be configured for controlling the second valve V2 to open the first port and the second port of the second valve V2 and close the third port of the second valve V2 in the air conditioning device 20. Accordingly, the second refrigerant line 21b may fluidically-communicate with the third refrigerant line 21c, and the first refrigerant branch line 41 may be blocked.

The controller 60 may be configured for controlling the third valve V3 to fluidically-communicate the second port of the third valve V3 with the fourth port of the third valve V3 and close the first port and the third port of the third valve V3. Accordingly, the fourth refrigerant line 21d may fluidically-communicate with the second refrigerant branch line 42, and a portion of the fifth refrigerant line 21e and the fourth refrigerant branch line 44 may be blocked.

The controller 60 may be configured for controlling the fourth valve V4 to fluidically-communicate the first port of the fourth valve V4 with the third port of the fourth valve V4 and close the second port and the fourth port of the fourth valve V4. Accordingly, the third refrigerant line 21c may fluidically-communicate with the fourth refrigerant line 21d, and the third refrigerant branch line 43 and the fourth refrigerant branch line 44 may be blocked.

Accordingly, the first refrigerant line 21a, the second refrigerant line 21b, the third refrigerant line 21c, the fourth refrigerant line 21d, the second refrigerant branch line 42, and the fifth refrigerant line 21e may sequentially fluidically-communicate with each other to form a loop for circulation of the coolant.

In the loop for the circulation of the refrigerant, the refrigerant flowing out from the compressor 22 may flow into the condenser 23, the refrigerant flowing out from the condenser 23 may flow into the heat-exchanger 24, the refrigerant flowing out from the heat-exchanger 24 may flow into the chiller 32, and the refrigerant flowing out from the chiller 32 may flow into the compressor 22 again.

The controller 60 may be configured for controlling the compressor 22 to be operated, and may be configured for controlling the expansion valve EXV to expand the refrigerant flowing into the heat-exchanger 24 and the chiller 32. In the instant case, the heat-exchanger 24 and the chiller 32 may be used as an evaporator.

There may be heat-exchange between the loop for the circulation of the coolant and the loop for the circulation of the refrigerant. The coolant whose temperature rises while it passes through the electric device 12 may cool the coolant by exchanging heat with the expanded refrigerant within the second refrigerant branch line 42 in the chiller 32, and the cooled coolant may cool the electric device 12 while passing through the electric device 12 again. Therefore, the electric device 12 may be cooled using the chiller 32. An air introduced into the vehicle may be cooled by the refrigerant within the heat-exchanger 24 while passing through the heat-exchanger 24 configured as the evaporator to realize cooling of the vehicle cabin.

Because a method of determining the rotation speed (EWP) of the pump 13 and the duty cycle (DUTY) of the cooling fan 15 in the fourth mode is the same as those in the second and third modes, a redundant description is omitted here.

If a temperature of the electric device 12 is too high in a case in which the interior of the vehicle and the electric device 12 need to be cooled through the fourth mode configured as described above, some refrigerants within the air conditioner 20 may be used for cooling the interior of the vehicle, and the remaining refrigerant may be used for cooling the electric device 12.

As shown in FIG. 7, in the fifth mode, the controller 60 may be configured for controlling the first valve V1 to close the first port of the first valve V1 and open the second port and the third port of the first valve V1 in the cooling device 10. Accordingly, the first coolant line 11a may fluidically-communicate with the coolant branch line 31, and the second coolant line 11b may be blocked to form a loop for circulation of the coolant.

In the loop for the circulation of the coolant, the coolant flowing out from the electric device 12 may flow into the pump 13, the coolant flowing out from the pump 13 may flow into the chiller 32 through the coolant branch line 31, and the coolant flowing out from the chiller 32 may flow into the electric device 12 again through the first coolant line 11a.

Therefore, through an operation of the first valve V1, the coolant whose temperature rises while it passes through the electric device 12 may flow into the coolant branch line 31 without passing through the radiator 14.

The controller 60 may be configured for controlling the pump 13 to be operated.

The controller 60 may be configured for controlling the second valve V2 to open the first port and the second port of the second valve V2 and close the third port of the second valve V2 in the air conditioning device 20. Accordingly, the second refrigerant line 21b may fluidically-communicate with the third refrigerant line 21c, and the first refrigerant branch line 41 may be blocked.

The controller 60 may be configured for controlling the third valve V3 to fluidically-communicate the first port of the third valve V3 with the fourth port of the third valve V3 and close the second port and the third port of the third valve V3. Accordingly, the fourth refrigerant branch line 44 may fluidically-communicate with the second refrigerant branch line 42, and a portion of the fifth refrigerant line 21e and the fourth refrigerant line 21d may be blocked.

The controller 60 may be configured for controlling the fourth valve V4 to fluidically-communicate the first port of the fourth valve V4 with the fourth port of the fourth valve V4 and close the second port and the third port of the fourth valve V4. Accordingly, the third refrigerant line 21c may fluidically-communicate with the fourth refrigerant branch line 44, and the third refrigerant branch line 43 and the fourth refrigerant line 21d may be blocked.

Accordingly, the first refrigerant line 21a, the second refrigerant line 21b, the third refrigerant line 21c, the fourth refrigerant branch line 44, the second refrigerant branch line 42, and the fifth refrigerant line 21e may sequentially fluidically-communicate with each other to form a loop for circulation of the refrigerant.

In the loop for the circulation of the refrigerant, the refrigerant flowing out from the compressor 22 may flow into the condenser 23, the refrigerant flowing out from the condenser 23 may flow into the chiller 32, and the refrigerant flowing out from the chiller 32 may flow into the compressor 22 again.

The controller 60 may be configured for controlling the compressor 22 to be operated, and may be configured for controlling the expansion valve EXV to expand the refrigerant flowing into the chiller 32. In the instant case, the chiller 32 may be used as an evaporator.

There may be heat-exchange between the loop for the circulation of the coolant and the loop for the circulation of the refrigerant. The coolant whose temperature rises while it passes through the electric device 12 may cool the coolant by exchanging heat with the expanded refrigerant within the second refrigerant branch line 42 in the chiller 32, and the cooled coolant may cool the electric device 12 while passing through the electric device 12 again. Therefore, the electric device 12 may be cooled using the chiller 32.

Because a method of determining the rotation speed (EWP) of the pump 13 and the duty cycle (DUTY) of the cooling fan 15 in the fifth mode is the same as those in the second, third, and fourth modes, a redundant description is omitted here.

If a temperature of the electric device 12 is too high in a case in which the air conditioning device 20 is not operated (i.e., in a case in which the air conditioning device 20 does not only need to heat the interior of the vehicle but also does not need to cool the interior of the vehicle) through the fifth mode configured as described above, the electric device 12 may also be cooled using the chiller 32.

Because an operation of each valve including the first valve V1, the second valve V2, the third valve V3, the fourth valve V4, and the expansion valve EXV in the sixth and seventh modes is the same as that in the fifth mode shown in FIG. 7, a redundant description is omitted here.

A difference between the fifth mode and the sixth mode may be as follows. In the sixth mode, the vehicle may be driven in the sixth driving mode (i.e., the super performance mode), and electric power output of a motor included in the electric device 12 in the sixth driving mode is higher than those of other driving modes (i.e., the first to fifth driving modes and the seventh driving mode). To ensure that the motor may stably and continuously output high electric power in the sixth driving mode, a cooling effect of the motor should be maximized. Therefore, a method of determining the rotation speed (EWP) of the pump 13 and the duty cycle (DUTY) of the cooling fan 15 in the sixth mode may not be completely the same as those in the second to fifth modes.

For example, the controller 60 may be configured to determine the rotation speed (EWP) of the pump 13 according to the sixth driving mode and the motor temperature (T). The controller 60 may be configured for controlling the pump 13 to be operated in response thereto. Table 6 below may show a mapping relationship between the rotation speed (EWP) of the pump 13 and the motor temperature (T) in the sixth driving mode.

TABLE 6

| T | 30 | 40 | 50 | 60 | 70 | 80 | 110 | 120 | 130 |
|---|---|---|---|---|---|---|---|---|---|
| EWP | 2000 | 2500 | 3000 | 3600 | 3600 | 3600 | 3600 | 3600 | 3600 |

Comparing Table 3 with Table 6, the rotation speed (EWP) of the pump 13 corresponding to the sixth driving mode may be greater than the rotation speed (EWP) of the pump 13 corresponding to other driving modes including the first to fifth driving modes if the motor temperature (T) is the same. Therefore, a cooling effect of the electric device 12 may be further improved.

The controller 60 may be configured to determine the duty cycle (DUTY) of the cooling fan 15 based on one of the motor temperature (T′) after modification and the accelerator pedal opening degree (α), and may be configured for controlling the cooling fan 15 to be operated.

Similarly to the second to fifth modes, if the duty cycle (DUTY_{T}) of the cooling fan 15 corresponding to the motor temperature (T′) after modification is greater than the duty cycle (DUTY_{α}) of the cooling fan 15 corresponding to the accelerator pedal opening degree (α), the controller 60 may be configured to determine the duty cycle (DUTY_{T}) of the cooling fan 15 corresponding to the motor temperature (T′) after modification as the duty cycle (DUTY) for controlling the operation of the cooling fan 15. Table 7 below may show a mapping relationship between the duty cycle (DUTY) of the cooling fan 15 and the motor temperature (T′) after modification in the sixth driving mode.

TABLE 7

| T′ | 50 | 60 | 70 | 80 | 90 | 100 | 110 | 120 | 130 | 140 | 150 |
|---|---|---|---|---|---|---|---|---|---|---|---|
| DUTY | 65 | 80 | 90 | 90 | 90 | 90 | 90 | 90 | 90 | 90 | 90 |

Table 7 only exemplarily shows the mapping relationship between the duty cycle (DUTY) of the cooling fan 15 and the motor temperature (T′) after modification, but an exemplary embodiment of the present disclosure is not limited thereto, and values of Table 7 may be changed as necessary.

Conversely, if the duty cycle (DUTY_{α}) of the cooling fan 15 corresponding to the accelerator pedal opening degree (α) is higher than the duty cycle (DUTY_{T}) of the cooling fan 15 corresponding to the motor temperature (T′) after modification, the controller 60 may be configured to determine the duty cycle (DUTY_{α}) of the cooling fan 15 corresponding to the accelerator pedal opening degree (α) as the duty cycle (DUTY) for controlling the operation of the cooling fan 15. Table 8 below may show a mapping relationship between the duty cycle (DUTY) of the cooling fan 15 and the accelerator pedal opening degree (α) in the sixth driving mode.

TABLE 8

| α | 20 | 30 | 40 | 50 | 60 | 70 |
|---|---|---|---|---|---|---|
| DUTY | 20 | 40 | 50 | 65 | 80 | 100 |

Table 8 only exemplarily shows the mapping relationship between the duty cycle (DUTY) of the cooling fan 15 and the accelerator pedal opening degree (α), but an exemplary embodiment of the present disclosure is not limited thereto, and values of Table 8 may be changed as necessary.

If the duty cycle (DUTY_{T}) of the cooling fan 15 corresponding to the motor temperature (T′) after modification and the duty cycle (DUTY_{α}) of the cooling fan 15 corresponding to the accelerator pedal opening degree (α) are the same, the controller 60 may be configured to determine one of the duty cycle (DUTY_{T}) and the duty cycle (DUTY_{α}) as the duty cycle (DUTY) for controlling the operation of the cooling fan 15.

For example, if the motor temperature (T′) after modification is 110° C. and the accelerator pedal opening degree (α) is 60%, the controller 60 may be configured to determine the duty cycle (DUTY_{T}) of the cooling fan 15 corresponding to the motor temperature (T′) after modification as 90, and may be configured to determine the duty cycle (DUTY_{α}) of the cooling fan 15 corresponding to the accelerator pedal opening degree (α) as 80 according to Tables 7 and 8 above. Because the duty cycle (DUTY_{T}) is greater than the duty cycle (DUTY_{α}), the controller 60 may be configured to determine the duty cycle (DUTY_{T}) as the duty cycle (DUTY) for controlling the operation of the cooling fan 15.

As an exemplary embodiment of the present disclosure, if the motor temperature (T′) after modification is 60° C. and the accelerator pedal opening degree (α) is 60%, the controller 60 may be configured to determine the duty cycle (DUTY_{T}) of the cooling fan 15 corresponding to the motor temperature (T′) after modification as 80, and may be configured to determine the duty cycle (DUTY_{α}) of the cooling fan 15 corresponding to the accelerator pedal opening degree (α) as 80 according to Tables 7 and 8 above. Because the duty cycle (DUTY_{T}) and the duty cycle (DUTY_{α}) are the same, the controller 60 may be configured to determine one of the duty cycle (DUTY_{T}) and the duty cycle (DUTY_{α}) as the duty cycle (DUTY) for controlling the operation of the cooling fan 15 (i.e., the duty cycle (DUTY) is 80).

If the vehicle is driven in the super performance mode through the sixth mode configured as described above, a cooling effect of the electric device 12 may be improved by using all of refrigerants within the air conditioning device 20.

In the seventh mode, the vehicle may be driven in the seventh driving mode (i.e., the safety mode). In general, the vehicle may execute the seventh mode only when the radiator 14 at the front of the vehicle may not operate normally (e.g., damage due to collision). Because the electric device 12 may not be cooled using the radiator 14 in the seventh mode, the electric device 12 should be cooled using the chiller 32 to ensure a normal operation of the motor included in the electric device 12.

If the vehicle is driven in the seventh driving mode, the vehicle is more likely to be damaged. Therefore, in the seventh mode, the vehicle speed (V) may be limited to a predetermined vehicle speed or less. For example, the predetermined vehicle speed may be 40 kph or less. Output electric power of a battery that is a power source of an electric vehicle may be limited to a predetermined electric power or less. For example, the predetermined electric power may be 5 kW. The rotation speed (EWP) of the pump 13 may be limited to a predetermined rotation speed or less. For example, the predetermined rotation speed may be 1000 rpm. Therefore, it is ensured that the vehicle may reach a safe place by driving a predetermined distance even when the vehicle may be damaged.

If the vehicle is driven in the safety mode through the seventh mode configured as described above, it is possible to ensure that the vehicle may safely drive using all of refrigerants within the air conditioning device 20 for cooling of the electric device 12 while limiting operating parameters of various portions within the vehicle.

In one new four-way valve included in the thermal management system of the vehicle according to an exemplary embodiment of the present disclosure, a first port may selectively fluidically-communicate with a fourth port, and a second port and a third port may be closed. Additionally, in the one new four-way valve, the second port may selectively fluidically-communicate with the third port, and the first port and the fourth port may be closed. Additionally, in the one new four-way valve, the second port may selectively fluidically-communicate with the fourth port, and the first port and the third port may be closed.

In another new four-way valve included in the thermal management system of the vehicle according to an exemplary embodiment of the present disclosure, a first port may selectively fluidically-communicate with a fourth port, and a second port may selectively fluidically-communicate with a third port. Additionally, in the other new four-way valve, the first port may selectively fluidically-communicate with the third port, and the second port and the fourth port may be closed. Additionally, in the other new four-way valve, the first port may selectively fluidically-communicate with the fourth port, and the second port and the third port may be closed.

An exemplary embodiment of the present disclosure may implement the thermal management system with a new layout including a connection relationship between a line, a valve, and a member using two new four-way valves, and the thermal management system may improve cooling performance of the motor to enable the motor to stably and continuously output high electric power.

While the present disclosure has been described in connection with what is presently considered to be practical embodiments, it should be understood that the present disclosure is not limited to the disclosed exemplary embodiments of the present disclosure, but, on the other hand, is directed to cover various modifications and equivalent claims as well as various alternatives and modifications thereof. It is intended that the scope of the present disclosure be defined by the Claims appended hereto and their equivalents.”

What is claimed is:

1. A thermal management system of a vehicle, the system comprising:
a cooling device that includes at least one electric device, a pump, a radiator, and a first valve sequentially connectable through a coolant line and is configured to cool the at least one electric device; and
an air conditioning device that includes a compressor, a condenser, a second valve, an expansion valve, and a heat-exchanger sequentially connectable through a refrigerant line,
wherein the cooling device further includes:
a coolant branch line including a first end portion connected to the coolant line downstream of the pump and a second end portion connected to the coolant line upstream of the at least one electric device through a first valve; and
a chiller that is disposed at the coolant branch line and is connected to the air conditioning device so that a coolant in the coolant branch line passes through the chiller and exchanges heat with a refrigerant from the air conditioning device in the chiller, and
wherein the air conditioning device further includes:
a third valve disposed at the refrigerant line downstream of the heat-exchanger;
a fourth valve disposed at the refrigerant line downstream of the expansion valve;
a first refrigerant branch line including a first end portion connected to the refrigerant line downstream of the condenser through the second valve and a second end portion connected to the refrigerant line downstream of the heat-exchanger;
a second refrigerant branch line that has a first end portion connected to the third valve and a second end portion connected to the refrigerant line upstream of the compressor, wherein the chiller is disposed at the second refrigerant branch line to be connectable to the air conditioning device;
a third refrigerant branch line including a first end portion connected to the refrigerant line downstream of the compressor and a second end portion connected to the fourth valve; and
a fourth refrigerant branch line including a first end portion connected to the fourth valve and a second end portion connected to the third valve.

2. The thermal management system of claim 1,
wherein the third valve is a four-way valve, a first port of the third valve is connected to the second end portion of the fourth refrigerant branch line, a second port of the third valve is connected to the refrigerant line downstream of the heat-exchanger, a third port of the third valve is connected to the refrigerant line upstream of the compressor, and a fourth port of the third valve is connected to the first end portion of the second refrigerant branch line, and
wherein the fourth valve is a four-way valve, a first port of the fourth valve is connected to the refrigerant line downstream of the expansion valve, a second port of the fourth valve is connected to the second end portion of the third refrigerant branch line, a third port of the fourth valve is connected to the refrigerant line upstream of the heat-exchanger, and a fourth port of the fourth valve is connected to the first end portion of the fourth refrigerant branch line.

3. The thermal management system of claim 2,
wherein the first valve is a three-way valve, a first port of the first valve is connected to the coolant line downstream of the radiator, a second port of the first valve is connected to the coolant line upstream of the at least one electric device, and a third port of the first valve is connected to the coolant branch line downstream of the chiller, and
wherein the second valve is a three-way valve, a first port of the second valve is connected to the refrigerant line downstream of the condenser, a second port of the second valve is connected to the refrigerant line upstream of the expansion valve, and a third port of the second valve is connected to the first refrigerant branch line.

4. The thermal management system of claim 3, wherein the coolant line includes:
a first coolant line including a first end portion connected to the second port of the first valve and a second end portion connected to a downstream of the pump; and
a second coolant line including a first end portion connected to the second end portion of the first coolant line and the second end portion connected to the first port of the first valve, and
wherein a diameter of the first coolant line is greater than a diameter of the coolant branch line, and the diameter of the coolant branch line is greater than a diameter of the second coolant line.

5. The thermal management system of claim 4, wherein the refrigerant line comprises:
a first refrigerant line including a first end portion connected to an outlet of the compressor and a second end portion connected to the first end portion of the third refrigerant branch line;
a second refrigerant line including a first end portion connected to the second end portion of the first refrigerant line and the second end portion connected to the first port of the second valve;
a third refrigerant line including a first end portion connected to the second port of the second valve and a second end portion connected to the first port of the fourth valve;
a fourth refrigerant line including a first end portion connected to the third port of the fourth valve and a second end portion connected to the second port of the third valve; and
a fifth refrigerant line including a first end portion connected to the third port of the third valve and a second end portion connected to an inlet of the compressor.

6. The thermal management system of claim 5, further comprising:
a cooling fan disposed at the rear of the radiator and the condenser;
a vehicle speed sensor detecting a vehicle speed;
a temperature sensor detecting a temperature of a motor; and
an accelerator pedal opening degree sensor detecting an accelerator pedal opening degree; and
a controller including at least one processor and operatively connected to the cooling fan, the vehicle speed sensor, the temperature sensor, and the accelerator pedal opening degree sensor.

7. The thermal management system of claim 6, wherein:
in a case in which the air conditioning device performs heating of a vehicle cabin, the thermal management system executes a first mode based on that the temperature of the motor is less than a first predetermined temperature and the accelerator pedal opening degree is less than a first predetermined opening degree, and the thermal management system executes a second mode based on that the temperature of the motor is greater than or equal to the first predetermined temperature or the accelerator pedal opening degree is greater than or equal to the first predetermined opening degree;
in a case in which the air conditioning device performs cooling of the vehicle cabin, the thermal management system executes a third mode based on that the temperature of the motor is less than a second predetermined temperature and the accelerator pedal opening degree is less than a second predetermined opening degree, and the thermal management system executes a fourth mode based on that the temperature of the motor is greater than or equal to the second predetermined temperature or the accelerator pedal opening degree is greater than or equal to the second predetermined opening degree;
in a case in which the air conditioning device is not operated, the thermal management system executes a fifth mode based on that the temperature of the motor is greater than or equal to the second predetermined temperature or the accelerator pedal opening degree is greater than or equal to the second predetermined opening degree;
the thermal management system executes a sixth mode based on that a driving mode of the vehicle is a super performance mode; and
the thermal management system executes a seventh mode based on that the driving mode of the vehicle is a safety mode.

8. The thermal management system of claim 7, wherein, in the first mode, the first port of the first valve is closed and the second port and the third port of the first valve are opened to fluidically-communicate the first coolant line with the coolant branch line and block the second coolant line; the first port of the second valve is closed, and the second port and the third port of the second valve are opened; the first port of the third valve fluidically-communicates with the fourth port of the third valve, and the second port and the third port of the third valve are closed; the first port of the fourth valve fluidically-communicates with the fourth port of the fourth valve, and the second port of the fourth valve fluidically-communicates with the third port of the fourth valve to sequentially fluidically-communicate the first refrigerant line, the third refrigerant branch line, the fourth refrigerant line, the first refrigerant branch line, the third refrigerant line, the fourth refrigerant branch line, the second refrigerant branch line, and the fifth refrigerant line;
the expansion valve expands the refrigerant flowing into the chiller; and
the pump and the compressor are operated so that waste heat generated by the at least one electric device is recovered using the chiller for the heating of the vehicle cabin.

9. The thermal management system of claim 7, wherein, in the second mode, the first port, the second port, and the third port of the first valve are opened so that the first coolant line fluidically-communicates with both the second coolant line and the coolant branch line; the first port of the second valve is closed, and the second port and the third port of the second valve are opened; the first port of the third valve fluidically-communicates with the fourth port of the third valve, and the second port and the third port of the third valve are closed; the first port of the fourth valve fluidically-communicates with the fourth port of the fourth valve, and the second port of the fourth valve fluidically-communicates with the third port of the fourth valve to sequentially fluidically-communicate the first refrigerant line, the third refrigerant branch line, the fourth refrigerant line, the first refrigerant branch line, the third refrigerant line, the fourth refrigerant branch line, the second refrigerant branch line, and the fifth refrigerant line;
the expansion valve expands the refrigerant flowing into the chiller; and
the pump and the compressor are operated so that waste heat generated by the at least one electric device is recovered using the chiller for the heating of the vehicle cabin and simultaneously the at least one electric device is further cooled using the radiator.

10. The thermal management system of claim 7, wherein, in the third mode, the first port and the second port of the first valve are opened and the third port of the first valve is closed to fluidically-communicate the first coolant line with the second coolant line and block the coolant branch line; the first port and the second port of the second valve are opened, and the third port of the second valve is closed; the first port and the fourth port of the third valve are closed, and the second port of the third valve fluidically-communicates with the third port of the third valve; the first port of the fourth valve fluidically-communicates with the third port of the fourth valve, and the second port and the fourth port of the fourth valve are closed to sequentially fluidically-communicate the first refrigerant line, the second refrigerant line, the third refrigerant line, the fourth refrigerant line, and the fifth refrigerant line;
the expansion valve expands the refrigerant flowing into the heat-exchanger; and
the pump and the compressor are operated so that the at least one electric device is cooled using the radiator and the cooling of the vehicle cabin is performed using the air conditioning device.

11. The thermal management system of claim 7, wherein, in the fourth mode, the first port of the first valve is closed and the second port and the third port of the first valve are opened to fluidically-communicate the first coolant line with the coolant branch line and block the second coolant line; the first port and the second port of the second valve are opened, and the third port of the second valve is closed; the first port and the third port of the third valve are closed, and the second port of the third valve fluidically-communicates with the fourth port of the third valve; the first port of the fourth valve fluidically-communicates with the third port of the fourth valve, and the second port and the fourth port of the fourth valve are closed to sequentially fluidically-communicate the first refrigerant line, the second refrigerant line, the third refrigerant line, the fourth refrigerant line, the second refrigerant branch line, and the fifth refrigerant line;
the expansion valve expands the refrigerant flowing into the heat-exchanger and the chiller; and
the pump and the compressor are operated so that the at least one electric device is cooled using the chiller and the cooling of the vehicle cabin is performed using the air conditioning device.

12. The thermal management system of claim 7, wherein, in the fifth mode, the sixth mode, and the seventh mode, the first port of the first valve is closed and the second port and the third port of the first valve are opened to fluidically-communicate the first coolant line with the coolant branch line and block the second coolant line; the first port and the second port of the second valve are opened, and the third port of the second valve is closed; the first port of the third valve fluidically-communicates with the fourth port of the third valve, and the second port and the third port of the third valve are closed; the first port of the fourth valve fluidically-communicates with the fourth port of the fourth valve, and the second port and the third port of the fourth valve are closed to fluidically-communicate the first refrigerant line, the second refrigerant line, the third refrigerant line, the fourth refrigerant branch line, the second refrigerant branch line, and the fifth refrigerant line;
the expansion valve expands the refrigerant flowing into the chiller; and
the pump and the compressor are operated so that the at least one electric device is cooled using the chiller.

13. The thermal management system of claim 12, wherein, in the sixth mode, a rotation speed of the pump is determined according to the super performance mode and the temperature of the motor and the pump is operated according to the determined rotation speed; and
the temperature of the motor after modification is determined according to the temperature of the motor detected by the temperature sensor, a duty cycle of the cooling fan corresponding to the temperature of the motor after modification is determined according to the super performance mode and the temperature of the motor after modification, a duty cycle of the cooling fan corresponding to the accelerator pedal opening degree is determined according to the super performance mode and the accelerator pedal opening degree detected by the accelerator pedal opening degree sensor, a larger value between the duty cycle of the cooling fan corresponding to the temperature of the motor after modification and the duty cycle of the cooling fan corresponding to the accelerator pedal opening degree is determined as a duty cycle for controlling an operation of the cooling fan, and the cooling fan is operated at the determined duty cycle.

14. The thermal management system of claim 12, wherein, in the seventh mode, the vehicle speed is limited to a predetermined vehicle speed or less;
electric power output of a battery is limited to a predetermined electric power or less; and
a rotation speed of the pump is limited to a predetermined rotation speed or less.

15. The thermal management system of claim 7, wherein, in the first mode, a rotation speed of the pump is determined according to the driving mode of the vehicle and the temperature of the motor, and the pump is operated according to the determined rotation speed.

16. The thermal management system of claim 7, wherein, in the second mode, the third mode, the fourth mode, and the fifth mode, a rotation speed of the pump is determined according to the driving mode of the vehicle and the temperature of the motor and the pump is operated according to the determined rotation speed; and
the temperature of the motor after modification is determined according to the temperature of the motor detected by the temperature sensor, a duty cycle of the cooling fan corresponding to the temperature of the motor after modification is determined according to the driving mode of the vehicle and the temperature of the motor after modification, a duty cycle of the cooling fan corresponding to the accelerator pedal opening degree is determined according to the driving mode of the vehicle and the accelerator pedal opening degree detected by the accelerator pedal opening degree sensor, a larger value between the duty cycle of the cooling fan corresponding to the temperature of the motor after modification and the duty cycle of the cooling fan corresponding to the accelerator pedal opening degree is determined as a duty cycle for controlling an operation of the cooling fan, and the cooling fan is operated at the determined duty cycle.

17. The thermal management system of claim 7, wherein the first predetermined temperature, the second predetermined temperature, the first predetermined opening degree, and the second predetermined opening degree are determined based on the driving mode other than the super performance mode and the safety mode.

18. The thermal management system of claim 16, wherein based on that the duty cycle of the cooling fan corresponding to the temperature of the motor after modification and the duty cycle of the cooling fan corresponding to the accelerator pedal opening degree are the same, one of the duty cycle of the cooling fan corresponding to the temperature of the motor after modification and the duty cycle of the cooling fan corresponding to the accelerator pedal opening degree is determined as the duty cycle for controlling the operation of the cooling fan, and the cooling fan is operated according to the determined duty cycle.

19. The thermal management system of claim 16, wherein the temperature of the motor detected by the temperature sensor is modified according to the vehicle speed to determine the temperature of the motor after modification.
